(19) United States
(12) Patent Application Publication
(10) Pub. No.: US 2026/0362229 A1
(43) Pub. Date: Nov. 12, 2026

(54) Threshold-Based Control of Wireless Communication

(71) Applicant: TELEFONAKTIEBOLAGET LM ERICSSON (PUBL), Stockholm (SE)

(72) Inventors: Nithin Srinivasan, Cologne (DE); Helka-Liina Määttänen, Espoo (FI); Mattias Bergström, Sollentuna (SE)

(21) Appl. No.: 19/148,420

(22) PCT Filed: Feb. 5, 2024
(86) PCT No.: PCT/EP2024/052722

§ 371 Date: Jul. 16, 2025

Related U.S. Application Data
(60) Provisional application No. 63/443,206, filed on Feb. 3, 2023.

(51) Int. Cl. H04W 28/02; H04B 17/309; H04B 17/318; H04W 84/06; H04W 92/18

(52) U.S. Cl. CPC H04W 28/0278; H04B 17/328; H04B 17/346; H04W 28/0226; H04W 28/0231; H04W 84/06; H04W 92/18

(57) ABSTRACT

A user equipment, UE, (410, 420) receives, from a node of the wireless communication network, a configuration for buffer status reporting that includes one or more thresholds that restrict sending buffer status reports, BSRs. When data for transmission becomes available, the UE (410, 420) selectively sends a BSR for the available data based on the one or more thresholds and on one or more current operating conditions at the UE (410, 420).

### TECHNICAL FIELD

The present disclosure relates generally to wireless communication networks, and more specifically to improving device-to-device (D2D) communication between user equipment (UEs) in cases where resources for D2D communication are allocated by a network based on UE buffer status reports (BSRs) of data available for D2D communication.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with fourth-generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is divided into multiple slots of equal duration, with each slot including multiple OFDM-based symbols. Time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with greater SCS considered for future NR releases (e.g., in higher frequency bands).

To support UL communication from UE to a 3GPP radio access network (RAN), a UE reports the status of its buffers containing data waiting for UL transmission to the RAN. The UE reports this information in a medium access control (MAC) message called a buffer status report (BSR). The following BSR formats are used by UEs depending on various factors:
Short BSR format (fixed size),
Short Truncated BSR format (fixed size),
Long Truncated BSR format (variable size), and
Long BSR format (variable size).

In case a UE has not been granted sufficient UL resources to transmit a BSR, the UE may send a scheduling request (SR) to obtain UL resources. After receiving a BSR, a RAN node can adjust scheduling of UE UL transmissions accordingly, including granting UL resources for the UE to transmit the available data.

Sidelink (SL) is a type of device-to-device (D2D) communication in which UEs communicate with each other directly rather than indirectly via a 3GPP RAN. D2D was first introduced in LTE Rel-12, targeting public safety use cases and proximity-based services (ProSe). Subsequently, various extensions have been introduced to broaden the range of use cases that can benefit from D2D technology. For example, D2D extensions in LTE Rel-14 and Rel-15 include supporting vehicle-to-everything (V2X) communication.

3GPP Rel-16 specifies the NR SL interface and targets advanced V 2X services, including four primary groups of use cases: vehicles platooning, extended sensors, advanced driving, and remote driving. The advanced V2X services require a new SL in order to meet the stringent requirements in terms of latency and reliability. The NR SL is designed to provide higher system capacity and better coverage, and to allow for extension to support the future development of even more advanced V2X services and other related services.

Radio resources for NR SL communication are organized into one or more SL resource pools, with each SL resource pool including some number of RBs that span a range of time and frequency. In the frequency domain, each resource pool is divided into sub-channels, where each sub-channel is a group, set, or collection of RBs that are contiguous in frequency.

Furthermore, NR SL is designed such that it is operable both with and without network coverage and with varying degrees of interaction between the UEs and the RAN, including support for standalone, network-less operation. For example, national security and public safety (NSPS) services often need to operate without (or with partial) RAN coverage, such as during indoor firefighting, forest firefighting, earthquake rescue, sea rescue, etc. Network coverage extension is a crucial enabler in these scenarios. 3GPP Rel- 17 includes a study item for coverage extension for SL-based communication, including UE-to-network (U2N) relay for cellular coverage extension and UE-to-UE (U2U) relay for SL coverage extension.

BSRs are also used in relation to SL between UEs. Various conditions can trigger a UE to send a SL BSR to a RAN node (e.g., base station) in which it is located, as specified in 3GPP TS 38.321(v 17.3.0 ). The SL BSR provides the serving RAN node with information about SL data volume in the UE's MAC entity. Based on the particular triggering condition, a UE may send a regular SL BSR, a periodic SL BSR, or a padding SL BSR.

Airborne radio-controlled drones (i.e., unmanned aerial vehicles, UAVs) are becoming more and more common. Conventionally, drones have been limited to operate within the propagation range of radio signals from dedicated or associated controllers used by drone operators. However, recently functionality allowing drones to be remotely controlled over the cellular network has increased their range considerably, resulting in many well-documented, unauthorized incursions of UAVs into regulated airspace (e.g., around airports, stadiums, etc.).

In view of the above, there is a need for efficient and reliable control of wireless communication of a UE, specifically a UE corresponding to a UAV.

### SUMMARY

According to an embodiment, a method for communication in a wireless communication network is provided. According to the method, a user equipment (UE) receives, from a node of the wireless communication network, a configuration for buffer status reporting that includes one or more thresholds that restrict sending buffer status reports (BSRs). When data for transmission becomes available, the UE selectively sends a BSR for the available data based on the one or more thresholds and on one or more current operating conditions at the UE.

According to a further embodiment, a method for communication in a wireless communication network is provided. According to the method, a node of the wireless communication network sends, to one or more UEs, a configuration for buffer status reporting that includes one or more thresholds that restrict sending BSRs. When data for transmission becomes available at one of the UEs, the node receives from the UE a BSR for the available data based on one or more current operating conditions at the UE and the one or more thresholds.

According to a further embodiment, a UE is provided. The UE is configured to receive, from a node of a wireless communication network, a configuration for buffer status reporting that includes one or more thresholds that restrict sending BSRs. Further, the UE is configured to, when data for transmission becomes available, selectively send a BSR for the available data based on the one or more thresholds and on one or more current operating conditions at the UE.

According to a further embodiment, a UE is provided. The UE comprises processing circuitry and a memory storing computer-executable instructions that, when executed by the processing circuitry, cause the UE to receive, from a node of a wireless communication network, a configuration for buffer status reporting that includes one or more thresholds that restrict sending BSRs. Further, the memory stores computer-executable instructions that, when executed by the processing circuitry, cause the UE to, when data for transmission becomes available, selectively send a BSR for the available data based on the one or more thresholds and on one or more current operating conditions at the UE.

According to a further embodiment, a computer program or computer program product is provided, e.g., in the form of a non-transitory storage medium, which comprises computer-executable instructions that, when executed by the processing circuitry of a UE, cause the UE to receive, from a node of a wireless communication network, a configuration for buffer status reporting that includes one or more thresholds that restrict sending BSRs. Further, the computer-executable instructions cause the UE to, when data for transmission becomes available, selectively send a BSR for the available data based on the one or more thresholds and on one or more current operating conditions at the UE.

According to a further embodiment, a node for a wireless communication network is provided. The node is configured to send, to one or more UEs, a configuration for buffer status reporting that includes one or more thresholds that restrict sending BSRs. Further, the node is configured to, when data for transmission becomes available at one of the UEs, receive from the UE a BSR for the available data based on one or more current operating conditions at the UE and the one or more thresholds.

According to a further embodiment, a node for a wireless communication network is provided. The node comprises processing circuitry and a memory storing computer-executable instructions that, when executed by the processing circuitry, cause the node to send, to one or more UEs, a configuration for buffer status reporting that includes one or more thresholds that restrict sending BSRs. Further, the memory stores computer-executable instructions that, when executed by the processing circuitry, cause the node to, when data for transmission becomes available at one of the UEs, receive from the UE a BSR for the available data based on one or more current operating conditions at the UE and the one or more thresholds.

According to a further embodiment, a computer program or computer program product is provided, e.g., in the form of a non-transitory storage medium, which comprises computer-executable instructions that, when executed by the processing circuitry of a node of a wireless communication network, cause the node to send, to one or more UEs, a configuration for buffer status reporting that includes one or more thresholds that restrict sending BSRs. Further, the computer-executable instructions cause the node to, when data for transmission becomes available at one of the UEs, receive from the UE a BSR for the available data based on one or more current operating conditions at the UE and the one or more thresholds.

According to a further embodiment, a method for communication in a wireless communication network is provided. According to the method, a UE receives a configuration from a node of the wireless communication network, wherein the configuration includes one or more thresholds for altitude above ground level. Based on the thresholds and current altitude above ground level of the UE, the UE controls one or more wireless transmissions of the UE.

According to a further embodiment, a method for communication in a wireless communication network is provided. According to the method, a node of a wireless communication network sends, to one or more UEs, a configuration that includes one or more thresholds for altitude above ground level. Further, the node receives one or more wireless transmissions from the UE based current altitude above ground level of the UE and the one or more thresholds.

According to a further embodiment, a UE is provided. The UE is configured to receive a configuration from a node of the wireless communication network, wherein the configuration includes one or more thresholds for altitude above ground level. Further, the UE is configured to control one or more wireless transmissions of the UE based on the thresholds and current altitude above ground level of the UE.

According to a further embodiment, a UE is provided. The UE comprises processing circuitry and a memory storing computer-executable instructions that, when executed by the processing circuitry, cause the UE to receive a configuration from a node of the wireless communication network, wherein the configuration includes one or more thresholds for altitude above ground level. Further, the memory stores computer-executable instructions that, when executed by the processing circuitry, cause the UE to control one or more wireless transmissions of the UE based on the thresholds and current altitude above ground level of the UE.

According to a further embodiment, a computer program or computer program product is provided, e.g., in the form of a non-transitory storage medium, which comprises computer-executable instructions that, when executed by the processing circuitry of a UE, cause the UE to receive a configuration from a node of the wireless communication network, wherein the configuration includes one or more thresholds for altitude above ground level. Further, the computer-executable instructions cause the UE to to control one or more wireless transmissions of the UE based on the thresholds and current altitude above ground level of the UE.

According to a further embodiment, a node for a wireless communication network is provided. The node is configured to send, to one or more UEs, a configuration that includes one or more thresholds for altitude above ground level. Further, the node is configured to receive one or more wireless transmissions from the UE based current altitude above ground level of the UE and the one or more thresholds.

According to a further embodiment, a node for a wireless communication network is provided. The node comprises processing circuitry and a memory storing computer-executable instructions that, when executed by the processing circuitry, cause the node to send to one or more UEs, a configuration that includes one or more thresholds for altitude above ground level. Further, the memory stores computer-executable instructions that, when executed by the processing circuitry, cause the node to receive one or more wireless transmissions from the UE based current altitude above ground level of the UE and the one or more thresholds.

According to a further embodiment, a computer program or computer program product is provided, e.g., in the form of a non-transitory storage medium, which comprises computer-executable instructions that, when executed by the processing circuitry of a node of a wireless communication network, cause the node to send, to one or more UEs, a configuration that includes one or more thresholds for altitude above ground level and to receive one or more wireless transmissions from the UE based current altitude above ground level of the UE and the one or more thresholds.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows exemplary NR user plane (UP) and control plane (CP) protocol stacks.

FIG. 2 illustrates a high-level views of an exemplary 5G/NR network architecture.

FIG. 3 shows an exemplary arrangement of interfaces between two V2X UEs and a 3GPP RAN.

FIG. 4 shows three exemplary network coverage scenarios for two UEs and a gNB serving a cell.

FIG. 5 shows an exemplary SL resource pool with three (3) sub-channels, each of the consisting of four (4) RBs in frequency and a (periodically repeating) number of slots in time.

FIG. 6 shows an exemplary ASN.1 data structure for a BSR-Config information element (IE).

FIG. 7 shows an exemplary time-frequency grid for SL communication in a channel.

FIG. 8 shows an exemplary arrangement of UAS-to-UTM connectivity through two core networks (e.g., EPC and 5GC) and two RANs (e.g., E-UTRAN and NG-RAN).

FIG. 9 shows an exemplary ASN.1 data structure for a BSR-Config IE, according to some embodiments of the present disclosure.

FIG. 10 shows a flow diagram of an exemplary method for a UE (e.g., wireless device), according to some embodiments of the present disclosure.

FIG. 11 shows a flow diagram of an exemplary method for a RAN node (e.g., base station, eNB, gNB, ng-eNB, etc.), according to some embodiments of the present disclosure.

FIG. 12 shows an example of a power control configuration according to an embodiment of the present disclosure.

FIG. 13 shows a flow diagram of an exemplary method for a UE (e.g., wireless device), according to some embodiments of the present disclosure.

FIG. 14 shows a flow diagram of an exemplary method for a network node (e.g., RAN node, such as a base station, eNB, gNB, ng-eNB, etc.), according to some embodiments of the present disclosure.

FIG. 15 shows a flow diagram of an exemplary method for a UE (e.g., wireless device), according to some embodiments of the present disclosure.

FIG. 16 shows a flow diagram of an exemplary method for a network node (e.g., base station, eNB, gNB, ng-eNB, etc.), according to some embodiments of the present disclosure.

FIG. 17 shows a communication system according to some embodiments of the present disclosure.

FIG. 18 shows a UE according to some embodiments of the present disclosure.

FIG. 19 shows a network node according to some embodiments of the present disclosure.

FIG. 20 shows host computing system according to some embodiments of the present disclosure.

FIG. 21 is a block diagram of a virtualization environment in which functions implemented by some embodiments of the present disclosure may be virtualized.

FIG. 22 illustrates communication between a host computing system, a network node, and a UE via multiple connections, at least one of which is wireless, according to some embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device. However, the term “node” may be limited to a particular type of node (e.g., radio access node) based on its particular characteristics in any context of use.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

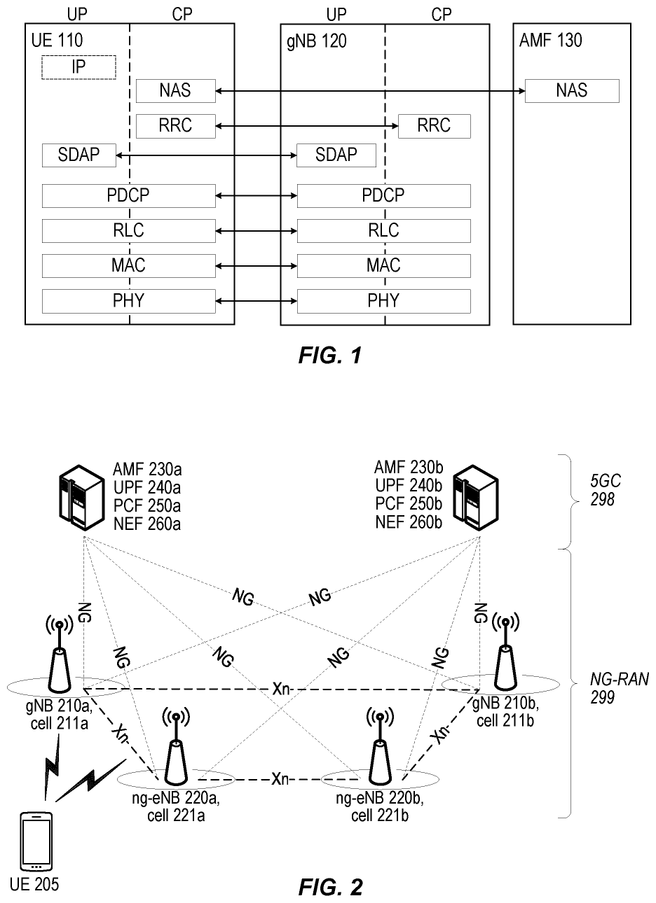

FIG. 1 shows an exemplary configuration of NR user plane (UP) and control plane (CP) protocol stacks between a UE (110), a gNodeB (gNB, e.g., base station, 120), and an access and mobility management function (AMF, 130) in the 5G core network (5GC). Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for CP and UP.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and establishes, configures, maintains, and releases DRBs and Signaling Radio Bearers (SRBs) used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC CONNECTED state (e.g., where data transfer can occur). The UE returns to RRC IDLE after the connection with the network is released. In RRC IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on physical DL control channel (PDCCH) for pages from 5GC via gNB. A UE in RRC IDLE state is not known to the gNB serving the cell where the UE is camping. However, NR RRC includes an RRC INACTIVE state in which a UE is known (e.g., via context) by the serving gNB.

FIG. 2 shows a high-level view of an exemplary 5G network architecture, including a Next Generation Radio Access Network (NG-RAN) 299 and a 5G Core (5GC) 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to the Access and Mobility Management Function (AMF, e.g., 230a,b) via respective NG-C interfaces and to the User Plane Function (UPF, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. In contrast, each of ng-eNBs can support the LTE radio interface but, unlike conventional LTE eNodeBs (eNBs), connect to the 5GC via the NG interface. Each of the gNBs and ng-eNBs can serve a geographic coverage area including one more cells, including cells 211a-b and 221a-b shown as exemplary in FIG. 2. The gNBs and ng-eNBs can also use various directional beams to provide coverage in the respective cells. Depending on the cell in which it is located, a UE 205 can communicate with the gNB or ng-eNB serving that cell via the NR or LTE radio interface, respectively.

The gNBs shown in FIG. 2 can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. As such, each of the CUs and DUs can include various circuitry needed to perform their respective functions, including processing circuitry, communication interface circuitry (e.g., for communication via Xn, NG, radio, etc. interfaces), and power supply circuitry.

NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval. An NR slot can also be arranged with various time-division duplexing (TDD) arrangements of UL and DL symbols. These TDD arrangements include:
DL-only (i.e., no UL transmission) slot with transmission late-start in symbol 1;
DL-heavy, with one UL symbol and guard periods before and after the UL symbol to facilitate change of transmission direction;
UL-heavy, with a single UL symbol that can carry DL control information; and
UL-only with transmission on-time start in symbol 0 and the initial UL symbol usable to carry DL control information.

In addition to providing coverage via cells as in LTE, NR networks also provide coverage via “beams.” In general, a DL “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DMRS, PTRS) are associated with specific UEs that have a network connection.

These RS are carried by various REs within DL RBs, which also carry various DL physical channels such as physical DL control channel (PDCCH), physical DL shared channel (PDSCH), physical broadcast channel (PBCH), etc. A UE can also transmit various UL physical channels and signals that are carried within UL RBs, such as physical UL control channel (PUCCH), physical UL shared channel (PUSCH), physical random access channel (PRACH), sounding RS (SRS), etc.

As briefly mentioned above, 3GPP Rel-16 specifies the NR sidelink (SL) interface and targets advanced V2X services including use cases such as vehicles platooning, extended sensors, advanced driving, and remote driving. The advanced V2X services require a new SL to meet service requirements of low latency and high reliability. The NR SL is designed to provide higher system capacity and better coverage, and to allow for extension to support the future development of even more advanced V2X services and other related services.

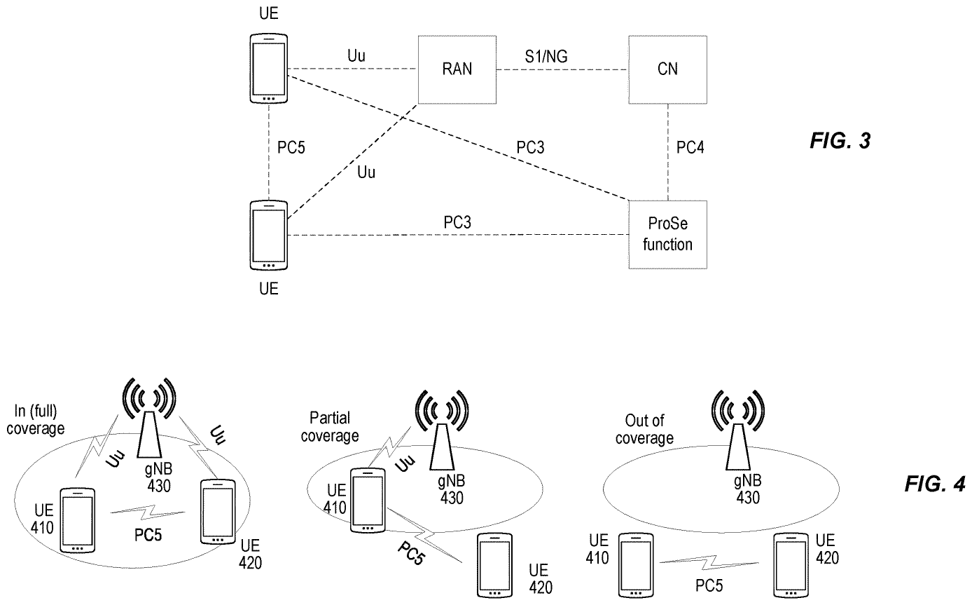

In general, a V2X UE can support unicast communication via the uplink/downlink radio interface (also referred to as “Uu”) to a 3GPP RAN, such as the LTE Evolved-UTRAN (E-UTRAN) or the NG-RAN. A V2X UE can also support SL unicast over the PC5 interface. FIG. 3 shows an exemplary arrangement of interfaces between two V2X UEs and a RAN. In addition to Uu and PC5 interfaces, the V2X UEs can communicate with a ProSe (PROximity-based SErvices) network function (NF) via respective PC3 interfaces. Communication with the ProSe NF requires a UE to establish a connection with the RAN, either directly via the Uu interface or indirectly via PC5 and another UE's Uu interface. The ProSe function provides the UE various information for network related actions, such as service authorization and provisioning of PLMN-specific information (e.g., security parameters, group IDs, group IP addresses, out-of-coverage radio resources, etc.).

FIG. 4 shows three exemplary network coverage scenarios for two UEs (410, 420) and a gNB (430) serving a cell. In the full coverage scenario (left), both UEs are in the coverage of the cell, such that they both can communicate with the gNB via respective Uu interfaces and directly with each other via the PC5 interface. In the partial coverage scenario (center), only one of the UEs is in coverage of the cell, but the out-of-coverage UE can still communicate with the gNB indirectly via the PC5 interface with the in-coverage UE. In the out-of-coverage scenario, both UEs can only communicate with each other via the PC5 interface.

In general, the term “SL standalone” refers to direct communication between two SL-capable UEs (e.g., via PC5) in which source and destination are the UEs themselves. In contrast, the term “SL relay” refers to indirect communication between a network node and a remote UE via a first interface (e.g., Uu) between the network node an intermediate (or relay) UE and a second interface (e.g., PC5) between the relay UE and the remote UE. In this case the relay UE is neither the source nor the destination.

In general, an “out-of-coverage UE” is one that cannot establish a direct connection to the network and must communicate via either SL standalone or SL relay. UEs that are in coverage can be configured by the network (e.g., gNB) via RRC signaling and/or broadcast system information, either directly (via Uu interface) or indirectly (via PC5 interface and relay UE Uu interface). Out-of-coverage UEs rely on a (pre-)configuration available in their SIMs. These pre-configurations are generally static but can be updated by the network when a UE is in coverage. A “peer UE” refers to a UE that can communicate with the out-of-coverage UE via SL standalone or SL relay (in which case the peer UE is also a relay UE).

3GPP Rel-17 includes further enhancements for NR SL. These include coverage extension for SL-based communication, including UE-to-network (U2N) relay for cellular coverage extension and UE-to-UE (U2U) relay for SL coverage extension. Other improvements include performance of power limited UEs (e.g., pedestrian UEs, first responder UEs, etc.). These improvements address various use cases including National Security and Public Safety (NSPS), Network Controlled Interactive Services (NCIS), etc.

To enable these and other enhancements, NR SL includes the following new physical channels and RS):
PSSCH (Physical SL Shared Channel, SL version of PDSCH): PSSCH is transmitted by a SL transmitter UE, and conveys SL, SIBs for RRC configuration, and a part of the SL control information (SCI, SL version of DL control information).
PSFCH (Physical SL feedback channel): The PSFCH is transmitted by a SL receiver UE for unicast and groupcast, and conveys one bit information over one RB for HARQ ACK or NACK. In addition, CSI is carried in a MAC control element (CE) over PSSCH instead of via PSFCH.
PSCCH (Physical SL Common Control Channel, SL version of PDCCH): When traffic to be sent to a receiver UE arrives at a transmitter UE, it should first send the PSCCH to convey a part of SCI to be decoded by any UE for channel sensing purpose. This part of SCI includes reserved time-frequency resources for transmissions, DMRS pattern and antenna port, etc.
SL Primary/Secondary Synchronization Signal (S-PSS/S-SSS): SL primary and secondary synchronization signals (S-PSS and S-SSS, respectively) are supported similar to DL PSS/SSS. By detecting S-PSS and S-SSS, a UE is able to identify the SL synchronization identity (SSID) of the sending UE (called “synchronization source”) and its associated characteristics. A process of acquiring timing and frequency synchronization and UE SSIDs is called initial cell search. Note that the UE sending S-PSS/S-SSS may not be necessarily involved in other SL transmissions. There are two S-PSS sequences and 336 S-SSS sequences, forming a total of 672 SSIDs in a cell.
Physical SL Broadcast Channel (PSBCH): PSBCH is transmitted along with the S-PSS/S-SSS as a synchronization signal/PSBCH block (SSB). The SSB has the same numerology as PSCCH/PSSCH on that carrier, and should be transmitted within the bandwidth of the configured bandwidth part (BWP). PSBCH conveys synchronization-related information such as direct frame number (DFN), indication of the slot and symbol level time resources for SL transmissions, in-coverage indicator, etc. SSB is transmitted every 160 ms.
DMRS, PT-RS, CSI-RS: These RS supported by NR DL are also supported on NL SL, including that PT-RS is only applicable for transmissions in frequency range 2 (FR2, e.g., above 6 GHz).

As mentioned above, unlike DCI on PDCCH, only a first part (or stage) of SCI is sent on PSCCH. This first stage is used for channel-sensing purposes and can be read by all UEs. The second stage is sent on PSSCH and includes scheduling and control information such as an 8-bit source ID, 16-bit destination ID, new data indicator (NDI), redundancy version (RV), and HARQ process ID. This second part can be decoded only by the intended receiver UE.

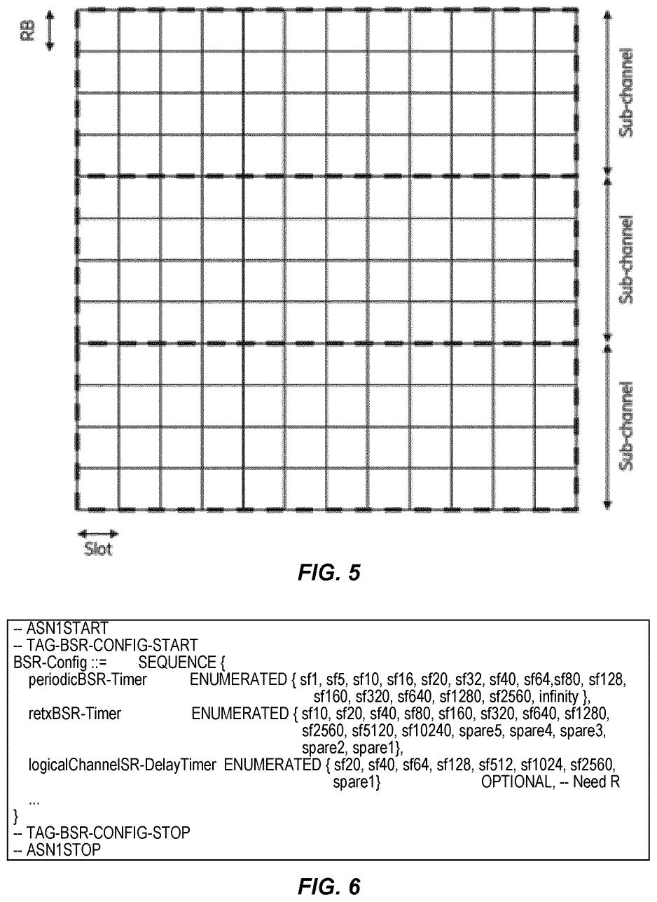

Radio resources for SL communication are organized into an SL resource pool spanning both time and frequency domains. In the time domain, the SL resource pool consists of NR slots indexed in an ascending order from zero to a maximum index value. Once this maximum index is reached, the slot indexing is repeated starting again from zero, and so on. In the frequency domain, each resource pool is divided into sub-channels, where each sub-channel is a group, set, or collection of RBs that are contiguous in frequency. FIG. 5 shows an exemplary SL resource pool with three (3) sub-channels, each of the consisting of four (4) RBs in frequency and a (periodically repeating) number of slots in time.

Two types of resource allocation modes are supported for NR SL between UEs. In NR SL resource allocation mode 1, all SL transmissions between UEs are scheduled by the network (e.g., a serving gNB) using a dynamic grant or a configured grant, as described below.

When the traffic to be sent over SL arrives at a transmitter UE, this UE launches a four-message procedure to request SL resources from a gNB: scheduling request (SR) in UL, an UL grant (via PDCCH) for sending a SL BSR, SL BSR sent using the UL grant (via PUSCH), and a SL grant (via PDCCH) for sending the data identified in the BSR. During this procedure, a gNB may allocate a SL radio network temporary identifier (SL-RNTI) to the transmitter UE. If a SL resource request is granted, the gNB indicates the resource allocation for PSCCH and the PSSCH in DCI on PDCCH with a CRC scrambled with the SL-RNTI.

When a transmitter UE receives such a DCI, it UE can obtain the grant only by descrambling the CRC using the assigned SL-RNTI. A transmitter UE then indicates the time-frequency resources and the transmission scheme of the allocated PSSCH in the PSCCH, and launches PSCCH and PSSCH on the resources allocated for SL transmissions. A transmitter UE can only transmit a single TB on a grant obtained from a gNB, making dynamic grants suitable only for traffic with loose latency requirements.

For the traffic with a strict latency requirement, performing the four-message exchange procedure to request SL resources induces unacceptable latency. Thus, prior to anticipated traffic arrival, a transmitter UE may request a set of resources via the four-message exchange procedure mentioned above. The gNB can reserve periodic SL resources according to the request and convey this to the UE in a SL configured grant, similar to an UL configured grant. When the anticipated traffic arrives, the transmitter UE can launch the PSCCH and the PSSCH during the next occasion of the resources of the configured grant. This process is also known as grant-free transmission.

The network (e.g., gNB) can provide a UE with SL configured grant via RRC. SL configured grants typically allocate resources having a periodic, semi-persistent pattern. Two types of configured SL grants are available, i.e., types 1 and 2. In type 2, the network can activate/deactivate the RRC-configured grant using DCI signaling. In other cases, the network may select the resources used for transmission but may give the transmitting SL UE some freedom to select some of the transmission parameters, possibly with some restrictions.

To control SL BSR operation of a UE, the serving gNB configures various parameters via the RRC information element (IE) sl-BSR-Config, which is another instantiation of the BSR-Config IE used to configure UE UL BSR reporting. FIG. 6 shows an exemplary ASN.1 data structure for a BSR-Config IE. Additionally, 3GPP TS 38.321(v 17.3.0 ) section 5.22.1.6 specifies that a SL BSR shall be triggered if any of the following events (or conditions) occur:
1> if the MAC entity has been configured with Sidelink resource allocation mode 1:
   2> SL data, for a logical channel of a Destination, becomes available to the MAC entity; and either:
      3> this SL data belongs to a logical channel with higher priority than the priorities of the logical channels containing available SL data which belong to any LCG belonging to the same Destination; or
      3> none of the logical channels which belong to an LCG belonging to the same Destination contains any available SL data.
      in which case the SL-BSR is referred below to as ‘Regular SL-BSR’;
   2> UL resources are allocated and number of padding bits remaining after a Padding BSR has been triggered is equal to or larger than the size of the SL-BSR MAC CE plus its subheader, in which case the SL-BSR is referred below to as ‘Padding SL-BSR’;
   2> sl-retxBSR-Timer expires, and at least one of the logical channels which belong to an LCG contains SL data, in which case the SL-BSR is referred below to as ‘Regular SL-BSR’; 2> sl-periodicBSR-Timer expires, in which case the SL-BSR is referred below to as ‘Periodic SL-BSR’.
1> else:
   2> Sidelink resource allocation mode 1 is configured by RRC and SL data is available for transmission in the RLC entity or in the PDCP entity, in which case the Sidelink BSR is referred below to as “Regular SL-BSR”.

The Destination of the SL data can be broadcast (i.e., all UEs), groupcast (i.e., some specific group of UEs), or unicast (i.e., a single UE). 3GPP TS 38.321 (v17.3.0 ) section 5.22.1.6 further specifies various actions that the UE performs for a Regular SL-BSR, a Periodic SL-BSR, and a Padding SL-BSR. Although not shown in the above conditions, a SL BSR can also preceded by a scheduling request (SR). Similar conditions and procedures for LTE SL BSR operation are specified in 3GPP TS 36.321 (v17.3.0 ) section 5.14.1.4.

In SL resource allocation mode 2, the resource allocation is performed by UE itself, e.g., autonomously based on sensing the carrier/resource pool for availability. In particular, the UE determines SL resource pool(s) by decoding sidelink control information (SCI) received from other UEs and/or by energy sensing, and selects a set of idle/available resources to use for its transmission of PSCCH and PSSCH. In this mode, there may be no intervention by the network (e.g., out of coverage, unlicensed carriers without a network deployment, etc.) or very minimal intervention by the network (e.g., configuration of pools of resources, etc.).

Note that SL resource allocation modes 1 and 2 only describe the behavior of a UE when acting as a SL transmitter. A SL receiver UE behaves the same regardless of SL transmitter mode. Moreover, signals used by SL transmitters operating in Mode 1 and Mode 2 transmitters are identical. LTE SL operation includes similar modes called network assisted scheduling (or mode 3) and autonomous scheduling (or mode 4).

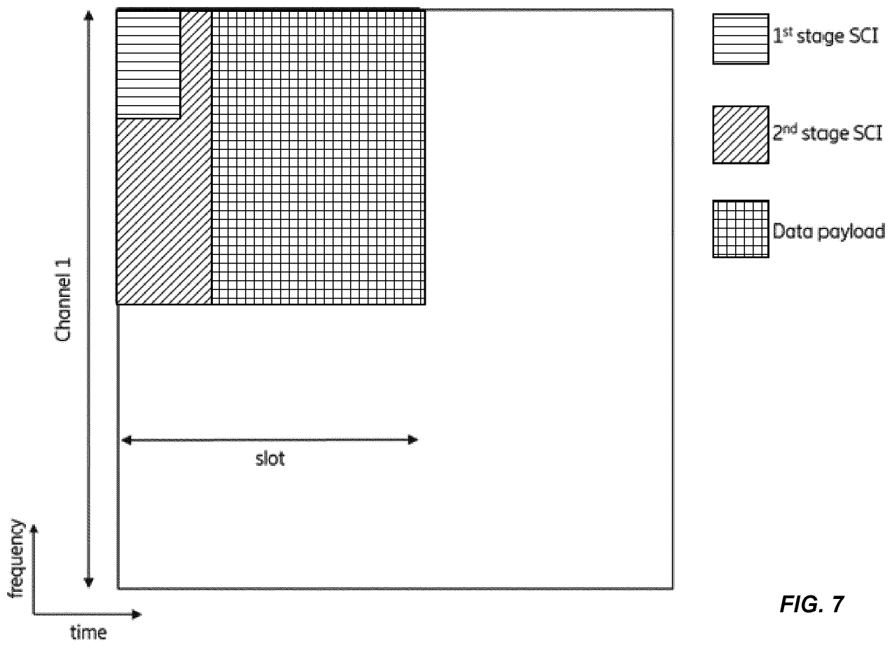

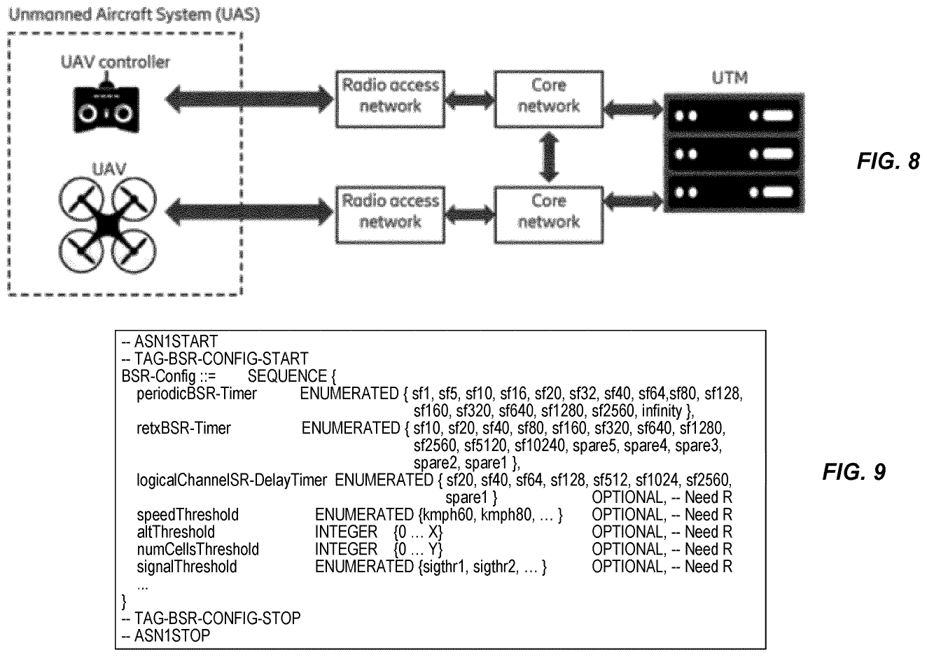

FIG. 7 shows an exemplary time-frequency grid for SL communication in a channel (labelled “Channel 1”). In particular, the first stage of SCI is carried by PSCCH in a first set of time-frequency resources, the second stage of SCI is carried by PSSCH in a second set of time-frequency resources, and the data payload scheduled by SCI is carried in a third set of time-frequency resources. For example, the SCI carries a scheduling assignment (SA) for receiving the data payload.

As briefly mentioned above, airborne radio-controlled drones (i.e., UAVs) are becoming more and more common. Conventionally, drones have been limited to operate within the propagation range of radio signals from dedicated or associated controllers used by drone operators. However, recently functionality allowing drones to be remotely controlled over a cellular (e.g., 3GPP) network has increased their range considerably, resulting in many well-documented, unauthorized incursions of UAVs into regulated airspace, e.g., around airports, sports stadiums, etc.

It is important to keep shared airspace safe and accessible. Therefore, a system called Unmanned Aircraft Systems (UAS) Traffic Management (UTM) is being developed in different parts of the world to manage the traffic of UAS. In this context, “UAS” refers to the combination of an unmanned aerial vehicle (UAV, e.g., aerial UE) and a UAV controller used by an operator with unique credentials and identities. According to the U.S. National Aeronautics and Space Administration (NASA), UTM is a collaborative, automated, and federated airspace management approach that enables safe, efficient, and equitable small UAS operations at scale.

UTM is being implemented by many countries and regions in the world, e.g., U.S., Europe, Japan, Australia, etc. UTM can provide various flight-related functions for UAVs and UAV operators, including but not limited to:
Remote UAV identification.
Operation planning, e.g., flight planning considering various aspects such as UAV performance, weather conditions, etc.
Operator messaging, e.g., message exchange between operators such as for position and status.
FAA messaging, e.g., on-demand, periodic, or event-triggered communications with FAA systems to meet regulatory requirements.
Mapping, e.g., information about airspace restrictions, obstacles, and sensitive regions.
Conflict advisory, e.g., real-time alerting for collision avoidance.

As discussed above, 3GPP networks can enable reliable connectivity between the UAV and its controller. Additionally, 3GPP networks can provide connectivity between UTM and the UAS, i.e., the UAV and/or the UAV controller. FIG. 9 shows an exemplary arrangement of UAS-to-UTM connectivity through two core networks (e.g., EPC and 5GC) and two RANs (e.g., E-UTRAN and NG-RAN).

One issue in regulating and/or enforcing boundaries on UAV usage is obtaining identification of UAVs that make unauthorized incursions into regulated airspace. To address this, 3GPP recently agreed to standardize broadcast of UAV identification (ID) for reception by law enforcement and other relevant government agencies (e.g., airport authorities). In particular, this information will be broadcast by UAVs via SL on NR or LTE PC5 interface.

Thus, this planned broadcast of UAV ID is one example of SL data for which a UE may need to send a SL BSR to a RAN node serving a cell in which the UE is located (i.e., when SL resource allocation mode 1 is used). Other types of SL data that may trigger a SL BSR includes control information and data exchanged between a UAV and its controller.

However, the existing SL BSR mechanism has some drawbacks that makes it unsuitable for UAVs. As an example, for UAVs traveling at relatively high speed and/or relatively high altitude, the existing SL BSR trigger conditions can result in frequent SL BSRs (or SRs) without the UAV being able to receive resources for SL transmission of the pending data. For example, when a UAV is traveling at high speeds and/or high altitudes, it may cross multiple cells in a short period of time. If the UAV sends a SL BSR while in a first cell, the UAV may have moved out of first cell coverage before the RAN node serving the first cell responds with an allocation of SL resources in the first cell. This scenario may be repeated several times. As a result, any resources allocated to the UE by RAN nodes are wasted, as are RAN node resources used to process the UAV's SL BSRs.

Embodiments of the present disclosure address these problems, issues, and/or drawbacks. For this purpose, UE may be configured with one or more thresholds to be used in controlling wireless transmissions of the UE. For example, such thresholds may be used for restricting SL buffer status reporting based on UE operating conditions. Some embodiments of the present disclosure provide efficient techniques for configuring UE SL BSR operation to account for specific characteristics of UAV operation. For example, the SL BSR configuration can include addition conditions, thresholds, etc. for triggering a SL BSR including thresholds for UE speed, altitude, number of cells received, signal strength (e.g., RSRP), interference strength (e.g., RSRQ or SINR), etc. When configured with one or more of these thresholds, UEs can only send SL BSRs when the UE's current conditions meet the configured thresholds.

For UAVs traveling at relatively high speed and/or relatively high altitude, the existing SL BSR trigger conditions can result in frequent SL BSRs (or SRs) without the UAV being able to receive resources for SL transmission of the pending data. For example, when a UAV is traveling at high speeds and/or high altitudes, it may cross multiple cells in a short period of time. If the UAV sends a SL BSR while in a first cell, the UAV may have moved out of first cell coverage before the RAN node serving the first cell responds with an allocation of SL resources in the first cell. This scenario may be repeated several times. As a result, any resources allocated to the UE by RAN nodes are wasted, as are RAN node resources used to process the UAV's SL BSRs.

Embodiments of the present disclosure provide improvements to SL communication by UAVs and other UEs, such as by providing, enabling, and/or facilitating solutions to overcome exemplary problems summarized above and described in more detail below.

Some embodiments include exemplary methods (e.g., procedures) for a UE configured for wireless SL communication with one or more other UEs in a radio access network (RAN).

These exemplary methods can include receiving, from a RAN node, a configuration for SL BSR that includes one or more thresholds that restrict sending SL BSRs to the RAN node. These exemplary methods can also include, when data for SL transmission becomes available, selectively sending a SL BSR for the available data based on the one or more thresholds and on one or more current operating conditions at the UE.

In some embodiments, the one or more thresholds include thresholds for any of the following: speed; altitude above ground level; number of cells in the RAN from which signals can be simultaneously received; geographic area in which sending SL BSR is allowed; geographic area in which sending SL BSR is prohibited; serving cell signal strength or quality; and neighbor cell interference level.

In some embodiments, the one or more current operating conditions at the UE include any of the following: UE speed; UE latitude and longitude; UE altitude above ground level; number of cells in the RAN for which the UE measures signal strength above a minimum; serving cell RSRP or RSRQ measured by the UE; and neighbor cell interference level measured by the UE.

In some embodiments, selectively sending a SL BSR for the available data to the RAN node based on the one or more thresholds and on one or more current operating conditions at the UE includes the following operations:
comparing one or more of the following current operating conditions at the UE to corresponding thresholds: UE speed, UE altitude above ground level, and number of cells in the RAN for which the UE measures signal strength above a minimum;
sending a SL BSR for the available data when each of the one or more current operating conditions at the UE is less than a corresponding threshold; and
refraining from sending a SL BSR for the available data when any of the one or more current operating conditions at the UE is not less than the corresponding threshold.

In some of these embodiments, sending a SL BSR for the available data when each of the one or more current operating conditions at the UE is less than a corresponding threshold includes the following operations:
triggering or initiating the sending of the SL BSR when each of the one or more operating conditions is less than a corresponding threshold;
measuring serving cell signal strength in response to the triggering or initiating; and
completing the sending the SL BSR when the measured serving cell signal strength is greater than a further signal strength threshold.

In some of variants of these embodiments, when the measured serving cell signal strength is not greater than the further signal strength threshold, selectively sending a SL BSR for the available data to the RAN node based on the one or more thresholds and on one or more current operating conditions at the UE also includes one of the following operations, labelled with corresponding sub-block numbers:
cancelling the sending of the SL BSR, when the SL BSR has not yet been sent; or
sending a SL BSR cancellation signal to the RAN node, when the SL BSR has been sent.

In some of these embodiments, refraining from sending a SL BSR for the available data when any of the one or more operating conditions is not less than the corresponding threshold includes performing autonomous resource allocation to obtain SL resources for transmission of the available data. In some of these embodiments, each threshold is associated with a corresponding offset, and a SL BSR is sent for the available data only when each of the one or more operating conditions is less than a corresponding threshold minus a corresponding offset.

In some embodiments, one or more thresholds that restrict sending SL BSRs to the RAN node include a first set of one or more thresholds associated with data traffic having a low priority. In such case, selectively sending a SL BSR is performed based on the first set of one or more thresholds when the available data is associated with the low priority and these exemplary methods also include, when the available data is associated with a higher priority, sending a SL BSR without regard to the one or more current operating conditions at the UE.

In other embodiments, the one or more thresholds that restrict sending SL BSRs to the RAN node include a first set of one or more thresholds associated with data traffic having a lower priority and a second set of thresholds associated with data traffic having a higher priority. In such case, selectively sending a SL BSR is performed based on the first set of one or more thresholds when the available data is associated with the lower priority and based on the second set of one or more thresholds when the available data is associated with the higher priority. For example, the first set of one or more thresholds can be more restrictive than the second set of one or more thresholds with respect to sending SL BSRs.

In some embodiments, the UE is an unmanned aerial vehicle (UAV) and/or the available data includes a UAV identifier.

In some embodiments, the configuration for SL BSR that includes the one or more thresholds is received via cell broadcast while the UE is in a non-connected state with respect to the RAN and these exemplary methods also include entering a connected state with respect to the RAN based on the one or more thresholds and on one or more current operating conditions at the UE. In such case, the SL BSR is selectively sent after entering the connected state.

In some embodiments, the SL BSR is selectively sent to the RAN node from which the configuration was received. In other embodiments, the SL BSR is selectively sent to a second RAN node after a handover of the UE from the RAN node to the second RAN node.

Other embodiments include exemplary methods (e.g., procedures) for a RAN node configured to facilitate wireless SL communication between a plurality of UEs. In general, these exemplary methods are complementary to the exemplary methods for a UE, summarized above.

These exemplary methods can include sending, to one or more UEs, a configuration for SL BSR that includes one or more thresholds that restrict sending SL BSRs to the RAN node. These exemplary methods can also include, when data for SL transmission becomes available at one of the UEs, receiving from the UE a SL BSR for the available data based on one or more current operating conditions at the UE meeting (e.g., being less than or greater than, as the case may be) the one or more thresholds.

In various embodiments, the one or more thresholds can include thresholds for any of the parameters mentioned above in relation to UE embodiments. In various embodiments, the one or more current operating conditions at the UE can include any of the operating conditions mentioned above in relation to UE embodiments.

In some embodiments, the current operating conditions at the UE include one or more of the following: UE speed, UE altitude above ground level, and number of cells in the RAN for which the UE measures signal strength above a minimum. In such case, a SL BSR for the available data is received when each of the one or more current operating conditions at the UE is less than a corresponding threshold, and a SL BSR for the available data is not received when any of the one or more current operating conditions at the UE is not less than the corresponding threshold.

In some of these embodiments, receiving the SL BSR for the available data in block 1120 is further based on UE measurements of serving cell signal strength, after triggering or initiating the sending of the SL BSR, being greater than a further signal strength threshold. In some variants, these exemplary methods can also include, after receiving the SL BSR, receiving a SL BSR cancellation signal from the UE.

In some of these embodiments, each threshold is associated with a corresponding offset, and a SL BSR is received for the available data only when each of the one or more current operating conditions at the UE is less than a corresponding threshold minus a corresponding offset.

In some embodiments, the one or more thresholds that restrict sending SL BSRs to the RAN node include a first set of one or more thresholds associated with data traffic having a low priority. When the available data is associated with the low priority, a SL BSR is received from the UE based on the one or more current operating conditions at the UE meeting the first set of one or more thresholds. However, when the available data is associated with a higher priority, a SL BSR is received from the UE regardless of the one or more current operating conditions at the UE.

In other embodiments, the one or more thresholds that restrict sending SL BSRs to the RAN node include a first set of one or more thresholds associated with data traffic having a lower priority and a second set of one or more thresholds associated with data traffic having a higher priority. When the available data is associated with the lower priority, a SL BSR is received from the UE based on the one or more current operating conditions at the UE meeting the first set of one or more thresholds. When the available data is associated with the higher priority, a SL BSR is received from the UE based on the one or more current operating conditions at the UE meeting the second set of one or more thresholds. For example, the first set of one or more thresholds can be more restrictive than the second set of one or more thresholds with respect to sending SL BSRs.

In some embodiments, the UE is a UAV and/or the available data includes a UAV identifier. In some embodiments, the configuration for SL BSR that includes the one or more thresholds is sent via cell broadcast while the UE is in a non-connected state with respect to the RAN. In such case, the SL BSR is received after the UE enters a connected state with respect to the RAN based on the one or more thresholds and on one or more current operating conditions at the UE.

Other embodiments include UEs (e.g., wireless devices) and RAN nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such UEs and RAN nodes to perform operations corresponding to any of the exemplary methods described herein.

These and other embodiments described herein can prevent and/or reduce unnecessary and/or excess sending of SL BSR (or preceding SR) as a UAV moves through coverage of a cell too quickly for resources to be allocated in that cell. This prevents and/or reduces unnecessary transmissions by the UAV, which reduces energy consumption and increases time of operation on a single battery charge (e.g., UAV range). Embodiments also reduce and/or eliminate unnecessary processing of SL BSRs by serving RAN nodes, which reduces energy consumption by those entities.

Embodiments as disclosed herein provide various benefits and/or advantages. For example, embodiments can prevent and/or reduce unnecessary and/or excess sending of SL BSR (or preceding SR) as a UAV moves through coverage of a cell too quickly for resources to be allocated in that cell. This prevents and/or reduces unnecessary transmissions by the UAV, which reduces energy consumption and increases time of operation on a single battery charge (e.g., UAV range). Embodiments also reduce and/or eliminate unnecessary processing of SL BSRs by serving RAN nodes, which reduces energy consumption by those entities. In the specific case of a signal strength threshold, embodiments can prevent a UAV from transmitting SL BSR in relatively poor signal environment, causing the UAV to wait until it reaches a more desirable location (e.g., nearer to RAN node or cell center).

In some embodiments, the UAV can receive from a serving RAN node a configuration for SL BSR, include thresholds that restrict triggering (or sending) SL-BSRs, including one or more of the following:
UAV speed (e.g., maximum);
UAV altitude (e.g., maximum above ground level)
Number of cells visible to UAV (e.g., observed signal strength above some minimum);
Geographic area (e.g., allowed or prohibited), which can be defined by various shapes such as circle, semi-circle, rectangle, etc.;
Serving cell signal strength observed by UAV (e.g., minimum RSRP, minimum RSRQ, etc.); and
Neighbor cell interference observed by UAV (e.g., minimum SINR). The network can configure one or any combination of these thresholds, e.g., speed threshold and altitude threshold.

In some embodiments, the configuration for SL BSR can be sent as an IE or field in an RRC message, e.g., RRCReconfiguration. As a more specific example, the one or more thresholds restricting the triggering (or sending) of SL BSRs can be included in a BSR-Config IE. FIG. 9 shows an exemplary ASN.1 data structure for a BSR-Config IE, according to some embodiments of the present disclosure. This exemplary data structure can be instantiated as a sl-BSR-Config IE such as discussed above, or be used to indicate a configuration for other types of BSR, e.g., a UL BSR (or Uu BSR). In addition to the fields shown in FIG. 6, the IE in FIG. 9 also includes four thresholds for triggering SL-BSR, including thresholds for speed, altitude, number of cells, and serving cell signal (e.g., strength or quality). Each of the four thresholds is optional, such that any combination of the thresholds can be included in the IE at the sending RAN node's discretion.

In some embodiments, upon receiving this configuration, the UAV can only trigger a SL-BSR upon meeting one or some combination of configured thresholds. For example, if the network configures speed and altitude thresholds, the UAV can trigger a SL-BSR only if its current speed and its current altitude (e.g., above ground level) are below the corresponding thresholds. As another example, if the network configures speed and number of cells thresholds, the UAV can trigger a SL-BSR only if its current speed and the number of cells currently visible to it (e.g., observed signal strength above some minimum) are below the corresponding thresholds.

In some embodiments, upon meeting one or some combination of the configured thresholds, the UAV triggers a SL-BSR and then performs signal measurements of its current serving cell (e.g., RSRP, RSRQ, SINR, etc.). If the signal measurements are below some further threshold (e.g., related to a handover procedure), the UAV cancels, stops, or suspends the triggered SL-BSR if not already transmitted. In a variant, if the triggered SL-BSR has been transmitted when the UAV determines the signal measurements are below the further threshold, the UAV can transmit another signal (e.g., SR, MAC CE, etc.) to its serving RAN node to cancel the SL-BSR. The other signal may implicitly or explicitly indicate the cancellation is due to an impending handover or worsening channel conditions.

In some embodiments, the configuration message including SL-BSR (including SR) triggering conditions as well as thresholds for the SL-BSR triggering conditions can be sent to the UAV while it is in coverage and in the RRC_CONNECTED state. For example, the information can be included in an RRCReconfiguration message such as discussed above. In some variants, when the serving RAN node hands over the RRC_CONNECTED UAV to a target RAN node, the serving RAN node can provide the UAV's SL-BSR triggering conditions and corresponding thresholds/restrictions to the target RAN node (e.g., via Xn interface).

In other embodiments, a RAN node can broadcast the SR/SL-BSR thresholds to be used in a cell in a system information broadcast (SIB, e.g., SIB12). Based on this information, the UAV can either request a SL resource allocation mode-1 configuration or choose to use SL resource allocation mode-2 (autonomous based on sensing). In a variant, the UAV UE can also decide to enter RRC CONNECTED state based on the SR/SL-BSR thresholds received via SIB broadcast. For example, the UAV can decide to enter RRC_CONNECTED if its current speed and its current altitude (e.g., above ground level) are below the corresponding thresholds received via broadcast, but otherwise decide to remain in RRC IDLE or RRC INACTIVE state.

In some embodiments, if the UAV is unable to trigger a SL-BSR due to not meeting the configured thresholds, the UAV can fallback to SL resource allocation mode-2 (autonomous based on sensing). In this way, the configured thresholds can be used by the UAV to determine in which SL resource allocation mode to operate.

In some embodiments, one or more of the configured SR/SL-BSR thresholds can also include a margin, hysteresis, or offset (collectively referred to as “offset”), which may be implicit or explicitly configured. The offset may be applied in both directions around the relevant threshold as settings for two different (e.g. opposite) operations. For example, when a UAV's altitude increases to greater than altitude threshold +altitude offset, the UAV refrains from sending SR/SL-BSR and/or falls back to SL resource allocation mode-2 (autonomous based on sensing). Then, when the UAV's altitude decreases to less than altitude threshold-altitude offset, the UAV resumes SL resource allocation mode-1 and sends SL-BSRs as needed.

In a variant, a timer may be used instead or in addition to an offset, such that UAV initiates a timer and stops sending SL BSR when its altitude exceeds the altitude threshold (opt.+altitude offset) and can only resume sending SL BSR when the timer has expired. The timer initial value may be received together with the thresholds (e.g., added to IE shown in FIG. 9).

In some embodiments, a UAV may apply different restrictions to triggering SL-BSRs for different types of traffic. Different types of traffic (e.g., different priorities) may be associated with different logical channels or with different logical channel groups (LCGs). As a simple example, the UAV may trigger SL-BSR for available high priority traffic (e.g., associated with a second LCG) but refrain from triggering SL-BSR for available low priority traffic (e.g., associated with a first LCG). As such, the UAV can send urgent traffic more quickly relative to less urgent traffic.

As a more detailed example, a configured set of one or more thresholds may be applicable to SL BSRs for available low priority traffic (e.g., first LCG) but not applicable to SL BSRs for available high priority traffic (e.g., second LCG). In other words, the SL BSR restrictions identified by the one or more thresholds are not applicable to the high priority traffic.

As another more detailed example, a first set of one or more thresholds may be applicable to SL BSRs for available high priority traffic (e.g., second LCG) and a second set of one or more thresholds may be applicable to SL BSRs for available low priority traffic (e.g., first LCG). The second set of one or more thresholds may be more restrictive than the first set of one or more thresholds (e.g., lower speed, lower altitude, fewer number of cells, etc.).

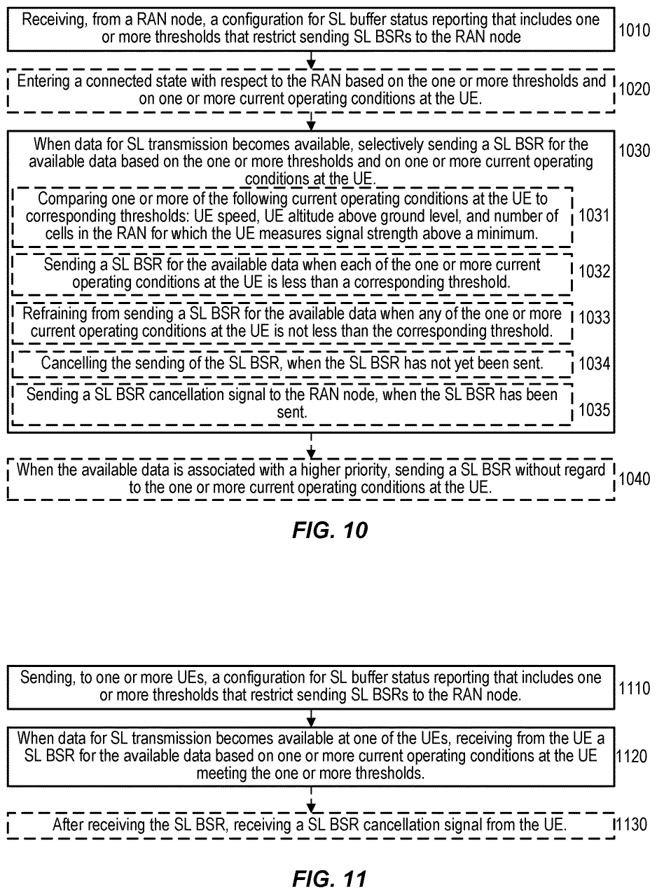

Various features of the embodiments described above correspond to various operations illustrated in FIGS. 10-11, which show exemplary methods (e.g., procedures) for a UE and a RAN node, respectively. In other words, various features of the operations described below correspond to various embodiments described above. Furthermore, the exemplary methods shown in FIGS. 10-11 can be used cooperatively to provide various benefits, advantages, and/or solutions to problems described herein. Although FIGS. 10-11 show specific blocks in particular orders, the operations of the exemplary methods can be performed in different orders than shown and can be combined and/or divided into blocks having different functionality than shown. Optional blocks or operations are indicated by dashed lines.

In particular, FIG. 10 shows an exemplary method (e.g., procedure) for a UE configured for wireless SL communication with one or more other UEs in a radio access network (RAN), according to various embodiments of the present disclosure. The exemplary method can be performed by a UE (e.g., wireless device) such as described elsewhere herein.

The exemplary method can include the operations of block 1010, where the UE can receive, from a RAN node, a configuration for SL buffer status reporting (BSR) that includes one or more thresholds that restrict sending SL BSRs to the RAN node. The exemplary method can also include the operations of block 1030, where when data for SL transmission becomes available, the UE can selectively send a SL BSR for the available data based on the one or more thresholds and on one or more current operating conditions at the UE.

In some embodiments, the one or more thresholds include thresholds for any of the following:
speed;
altitude above ground level;
number of cells in the RAN from which signals can be simultaneously received;
geographic area in which sending SL BSR is allowed;
geographic area in which sending SL BSR is prohibited;
serving cell signal strength or quality; and
neighbor cell interference level.

In some embodiments, the one or more current operating conditions at the UE include any of the following:
UE speed;
UE latitude and longitude;
UE altitude above ground level;
number of cells in the RAN for which the UE measures signal strength above a minimum;
serving cell RSRP or RSRQ measured by the UE; and
neighbor cell interference level measured by the UE.

In some embodiments, selectively sending a SL BSR for the available data to the RAN node based on the one or more thresholds and on one or more current operating conditions at the UE in block 1030 includes the following operations, labelled with corresponding sub-block numbers:
(1031) comparing one or more of the following current operating conditions at the UE to corresponding thresholds: UE speed, UE altitude above ground level, and number of cells in the RAN for which the UE measures signal strength above a minimum;
(1032) sending a SL BSR for the available data when each of the one or more current operating conditions at the UE is less than a corresponding threshold; and
(1033) refraining from sending a SL BSR for the available data when any of the one or more current operating conditions at the UE is not less than the corresponding threshold.

In some of these embodiments, sending a SL BSR for the available data when each of the one or more current operating conditions at the UE is less than a corresponding threshold in sub-block 1032 includes the following operations:
triggering or initiating the sending of the SL BSR when each of the one or more operating conditions is less than a corresponding threshold;
measuring serving cell signal strength in response to the triggering or initiating; and
completing the sending the SL BSR when the measured serving cell signal strength is greater than a further signal strength threshold.

In some of variants of these embodiments, when the measured serving cell signal strength is not greater than the further signal strength threshold, selectively sending a SL BSR for the available data to the RAN node based on the one or more thresholds and on one or more current operating conditions at the UE in block 1030 also includes one of the following operations, labelled with corresponding sub-block numbers:
(1034) cancelling the sending of the SL BSR, when the SL BSR has not yet been sent; or
(1035) sending a SL BSR cancellation signal to the RAN node, when the SL BSR has been sent.

In some of these embodiments, refraining from sending a SL BSR for the available data when any of the one or more operating conditions is not less than the corresponding threshold in sub-block 1033 includes performing autonomous resource allocation to obtain SL resources for transmission of the available data (e.g., in SL resource allocation mode-1, without sending SL BSR). In some of these embodiments, each threshold is associated with a corresponding offset, and a SL BSR for the available data is sent (e.g., in sub-block 1032) only when each of the one or more operating conditions is less than a corresponding threshold minus a corresponding offset.

In some embodiments, one or more thresholds that restrict sending SL BSRs to the RAN node include a first set of one or more thresholds associated with data traffic having a low priority. In such case, selectively sending a SL BSR in block 1030 is performed based on the first set of one or more thresholds when the available data is associated with the low priority and the exemplary method also includes the operations of block 1040, where when the available data is associated with a higher priority, the UE can send a SL BSR without regard to the one or more current operating conditions at the UE. In other words, the first set of one or more thresholds do not restrict sending of SL BSRs for higher-priority data.

In other embodiments, the one or more thresholds that restrict sending SL BSRs to the RAN node include a first set of one or more thresholds associated with data traffic having a lower priority and a second set of one or more thresholds associated with data traffic having a higher priority. In such case, selectively sending a SL BSR is performed (e.g., in block 1030) based on the first set of one or more thresholds when the available data is associated with the lower priority and based on the second set of one or more thresholds when the available data is associated with the higher priority. For example, the first set of one or more thresholds can be more restrictive than the second set of one or more thresholds with respect to sending SL BSRs.

In some embodiments, the UE is an unmanned aerial vehicle (UAV) and/or the available data includes a UAV identifier.

In some embodiments, the configuration for SL BSR that includes the one or more thresholds is received via cell broadcast while the UE is in a non-connected state with respect to the RAN and the exemplary method also includes the operations of block 1020, where the UE can enter a connected state with respect to the RAN based on the one or more thresholds and on one or more current operating conditions at the UE. In such case, the SL BSR is selectively sent (e.g., in block 1030) after entering the connected state. In some variants, the one or more current operating conditions include UE speed and UE altitude, and the connected state is entered with the UE speed and the UE altitude are less than corresponding thresholds.

In some embodiments, the SL BSR is selectively sent to the RAN node from which the configuration was received. In other embodiments, the SL BSR is selectively sent to a second RAN node after a handover of the UE from the RAN node to the second RAN node.

In addition, FIG. 11 shows an exemplary method (e.g., procedure) for a RAN node configured to facilitate wireless SL communication between a plurality of UEs, according to various embodiments of the present disclosure. The exemplary method can be performed by a RAN node (e.g., base station, eNB, gNB, ng-eNB, etc.) such as described elsewhere herein.

The exemplary method can include the operations of block 1110, where the RAN node can send, to one or more UEs, a configuration for SL buffer status reporting that includes one or more thresholds that restrict sending SL BSRs to the RAN node. The exemplary method can also include the operations of block 1120, where when data for SL transmission becomes available at one of the UEs, the RAN node can receive from the UE a SL BSR for the available data based on one or more current operating conditions at the UE meeting (e.g., being less than or greater than, as the case may be) the one or more thresholds.

In various embodiments, the one or more thresholds can include thresholds for any of the parameters mentioned above in relation to UE embodiments. In various embodiments, the one or more current operating conditions at the UE can include any of the operating conditions mentioned above in relation to UE embodiments.

In some embodiments, the current operating conditions at the UE include one or more of the following: UE speed, UE altitude above ground level, and number of cells in the RAN for which the UE measures signal strength above a minimum. In such case, a SL BSR for the available data is received when each of the one or more current operating conditions at the UE is less than a corresponding threshold, and a SL BSR for the available data is not received when any of the one or more current operating conditions at the UE is not less than the corresponding threshold.

In some of these embodiments, receiving the SL BSR for the available data in block 1120 is further based on UE measurements of serving cell signal strength, after triggering or initiating the sending of the SL BSR, being greater than a further signal strength threshold. In some variants, the exemplary method can also include the operations of block 1130 where after receiving the SL BSR (e.g., in block 1120), the RAN node can receive a SL BSR cancellation signal from the UE.

In some of these embodiments, each threshold is associated with a corresponding offset, and a SL BSR is received for the available data only when each of the one or more current operating conditions at the UE is less than a corresponding threshold minus a corresponding offset.

In some embodiments, the one or more thresholds that restrict sending SL BSRs to the RAN node include a first set of one or more thresholds associated with data traffic having a low priority. When the available data is associated with the low priority, a SL BSR is received from the UE based on the one or more current operating conditions at the UE meeting the first set of one or more thresholds. However, when the available data is associated with a higher priority, a SL BSR is received from the UE regardless of the one or more current operating conditions at the UE.

In other embodiments, the one or more thresholds that restrict sending SL BSRs to the RAN node include a first set of one or more thresholds associated with data traffic having a lower priority and a second set of one or more thresholds associated with data traffic having a higher priority. When the available data is associated with the lower priority, a SL BSR is received from the UE based on the one or more current operating conditions at the UE meeting the first set of one or more thresholds. When the available data is associated with the higher priority, a SL BSR is received from the UE based on the one or more current operating conditions at the UE meeting the second set of one or more thresholds. For example, the first set of one or more thresholds can be more restrictive than the second set of one or more thresholds with respect to sending SL BSRs.

In some embodiments, the UE is an unmanned aerial vehicle (UAV) and/or the available data includes a UAV identifier.

In some embodiments, the configuration for SL BSR that includes the one or more thresholds is sent via cell broadcast (e.g., in block 1110) while the UE is in a non-connected state with respect to the RAN. In such case, the SL BSR is received (e.g., in block 1120) after the UE enters a connected state with respect to the RAN based on the one or more thresholds and on one or more current operating conditions at the UE. In some of these embodiments, the one or more current operating conditions include UE speed and UE altitude, and the UE enters the connected state when the UE speed and the UE altitude are less than corresponding thresholds.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

It is also noted that the above-described principles of using a threshold-based configuration for controlling wireless transmissions of a UE may also be applied for other purposes than for restricting sending of SL BSRs. For example, the sending of other BSRs, e.g., UL BSRs (or Uu BSRs) could be restricted in a corresponding manner. Further, a threshold-based configuration could be used for controlling transmit power of a UE, e.g., transmit power of SL transmissions and/or transmit power of UL transmissions.

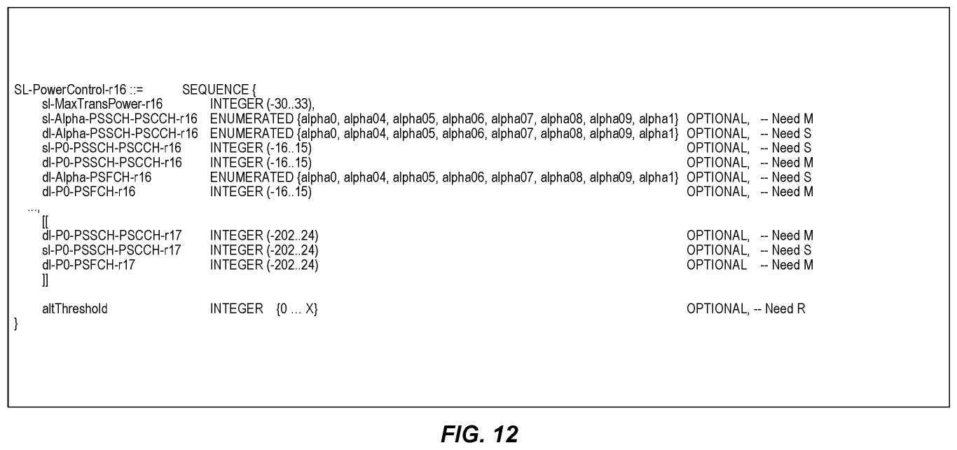

FIG. 12 shows an example of a transmit power control configuration of a UE which may be based on one or more thresholds for altitude above ground level of the UE. In this configuration, parameters designated by “dl-P0” are used by the UE to adjust its transmission power for SL transmissions. Here, the parameter dl-P0 may be set depending on pathloss between the UE and gNB. These parameters are used by the UE to adjust the transmit power of the individual SL channels, e.g., PSSCH, PSCCH, or PSFCH. For UAV UEs flying at higher altitudes, it can be expected that in most cases there is a line of sight to the gNB(s). Therefore, it is beneficial if the value of dl-P0 when the UE is at ground level is not reused at higher altitudes, as this could cause significant interference to the gNB(s). Depending on one or more thresholds for the altitude above ground level, in the example of FIG. 12 corresponding to parameter “altThreshold”, the UE may thus apply different values of dl-P0 depending on comparison of the current altitude of the UE to the threshold(s). In the illustrated example, the parameter indicating the threshold is optional. For example, if the UE altitude is above the threshold, the UE may reduce the value of the parameter by a factor or margin. Such factor or margin can be pre-configured or could also be defined by the transmit power control configuration.

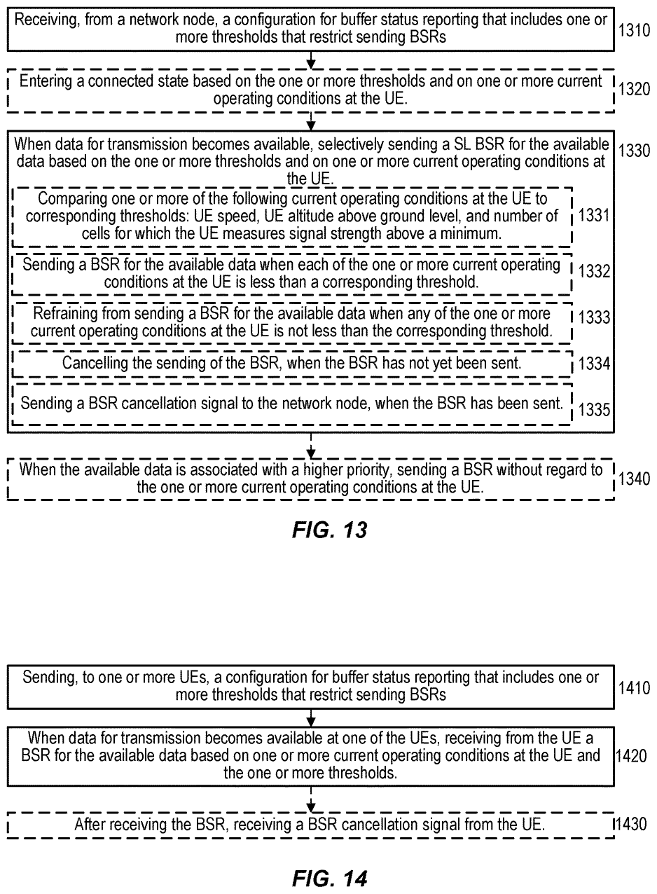

FIGS. 13-14 show further exemplary methods (e.g., procedures) for a UE and a network node, respectively. The network node may correspond to a RAN node. Although FIGS. 13-14 show specific blocks in particular orders, the operations of the exemplary methods can be performed in different orders than shown and can be combined and/or divided into blocks having different functionality than shown. Optional blocks or operations are indicated by dashed lines.

In particular, FIG. 13 shows an exemplary method (e.g., procedure) for a UE for operation in a wireless communication network. The exemplary method can be performed by a UE (e.g., wireless device) such as described elsewhere herein. In some embodiments, the UE can be a UE configured for SL communication with one or more other UEs.

The exemplary method can include the operations of block 1310, where the UE can receive, from a network node (such as a RAN node), a configuration for buffer status reporting that includes one or more thresholds that restrict sending BSRs. The exemplary method can also include the operations of block 1330, where when data for transmission becomes available, the UE can selectively send a BSR for the available data based on the one or more thresholds and on one or more current operating conditions at the UE. The BSR can be a SL BSR or some other BSR, e.g., a UL BSR (or Uu BSR).

In some embodiments, the one or more thresholds include thresholds for any of the following:
speed;
altitude above ground level;
number of cells in the RAN from which signals can be simultaneously received;
geographic area in which sending BSR is allowed;
geographic area in which sending BSR is prohibited;
serving cell signal strength or quality; and
neighbor cell interference level.

In some embodiments, the one or more current operating conditions at the UE include any of the following:
UE speed;
UE latitude and longitude;
UE altitude above ground level;
number of cells in the RAN for which the UE measures signal strength above a minimum;
serving cell RSRP or RSRQ measured by the UE; and
neighbor cell interference level measured by the UE.

In some embodiments, selectively sending a BSR for the available data based on the one or more thresholds and on one or more current operating conditions at the UE in block 1330 includes the following operations, labelled with corresponding sub-block numbers:
(1331) comparing one or more of the following current operating conditions at the UE to corresponding thresholds: UE speed, UE altitude above ground level, and number of cells in the RAN for which the UE measures signal strength above a minimum;
(1332) sending a BSR for the available data when each of the one or more current operating conditions at the UE is less than a corresponding threshold; and
(1333) refraining from sending a BSR for the available data when any of the one or more current operating conditions at the UE is not less than the corresponding threshold.

In some of these embodiments, sending a BSR for the available data when each of the one or more current operating conditions at the UE is less than a corresponding threshold in sub-block includes the following operations:
triggering or initiating the sending of the BSR when each of the one or more operating conditions is less than a corresponding threshold;
measuring serving cell signal strength in response to the triggering or initiating; and
completing the sending the BSR when the measured serving cell signal strength is greater than a further signal strength threshold.

In some of variants of these embodiments, when the measured serving cell signal strength is not greater than the further signal strength threshold, selectively sending a BSR for the available data based on the one or more thresholds and on one or more current operating conditions at the UE in block 1330 also includes one of the following operations, labelled with corresponding sub-block numbers:
(1334) cancelling the sending of the BSR, when the SL BSR has not yet been sent; or
(1335) sending a BSR cancellation signal when the BSR has been sent.

In some of these embodiments, refraining from sending a BSR for the available data when any of the one or more operating conditions is not less than the corresponding threshold in sub-block 1333 includes performing autonomous resource allocation to obtain SL resources for transmission of the available data (e.g., in SL resource allocation mode-1, without sending BSR). In some of these embodiments, each threshold is associated with a corresponding offset, and a BSR for the available data is sent (e.g., in sub-block 1332) only when each of the one or more operating conditions is less than a corresponding threshold minus a corresponding offset.

In some embodiments, one or more thresholds that restrict sending BSRs include a first set of one or more thresholds associated with data traffic having a low priority. In such case, selectively sending a BSR in block 1330 is performed based on the first set of one or more thresholds when the available data is associated with the low priority and the exemplary method also includes the operations of block 1340, where when the available data is associated with a higher priority, the UE can send a BSR without regard to the one or more current operating conditions at the UE. In other words, the first set of one or more thresholds do not restrict sending of BSRs for higher-priority data.

In other embodiments, the one or more thresholds that restrict sending BSRs node include a first set of one or more thresholds associated with data traffic having a lower priority and a second set of one or more thresholds associated with data traffic having a higher priority. In such case, selectively sending a BSR is performed (e.g., in block 1330) based on the first set of one or more thresholds when the available data is associated with the lower priority and based on the second set of one or more thresholds when the available data is associated with the higher priority. For example, the first set of one or more thresholds can be more restrictive than the second set of one or more thresholds with respect to sending BSRs.

In some embodiments, the UE is an unmanned aerial vehicle (UAV) and/or the available data includes a UAV identifier.

In some embodiments, the configuration for BSR that includes the one or more thresholds is received via cell broadcast while the UE is in a non-connected state and the exemplary method also includes the operations of block 1320, where the UE can enter a connected state based on the one or more thresholds and on one or more current operating conditions at the UE. In such case, the BSR is selectively sent (e.g., in block 1330) after entering the connected state. In some variants, the one or more current operating conditions include UE speed and UE altitude, and the connected state is entered with the UE speed and the UE altitude are less than corresponding thresholds.

In some embodiments, the BSR is selectively sent to the network node from which the configuration was received. In other embodiments, the BSR is selectively sent to a second network node (e.g., another RAN node) after a handover of the UE from the network node to the second network node.

In addition, FIG. 14 shows an exemplary method (e.g., procedure) for a network node (e.g., a RAN node) for a wireless communication netgork, according to various embodiments of the present disclosure. The exemplary method can be performed by a network node (e.g., a RAN node, such as a base station, eNB, gNB, ng-eNB, etc.) such as described elsewhere herein.

The exemplary method can include the operations of block 1410, where the network node can send, to one or more UEs, a configuration for buffer status reporting that includes one or more thresholds that restrict sending BSRs. In some embodiments, the UEs can be a UEs configured for SL communication with one or more other UEs. The exemplary method can also include the operations of block 1420, where when data for transmission becomes available at one of the UEs, the network node can receive from the UE a BSR for the available data based on one or more current operating conditions at the UE and the one or more thresholds, e.g., based on one or more current operating conditions at the UE meeting (e.g., being less than or greater than, as the case may be) the one or more thresholds.

In various embodiments, the one or more thresholds can include thresholds for any of the parameters mentioned above in relation to UE embodiments. In various embodiments, the one or more current operating conditions at the UE can include any of the operating conditions mentioned above in relation to UE embodiments.

In some embodiments, the current operating conditions at the UE include one or more of the following: UE speed, UE altitude above ground level, and number of cells in the RAN for which the UE measures signal strength above a minimum. In such case, a SL BSR for the available data is received when each of the one or more current operating conditions at the UE is less than a corresponding threshold, and a BSR for the available data is not received when any of the one or more current operating conditions at the UE is not less than the corresponding threshold.

In some of these embodiments, receiving the BSR for the available data in block 1420 is further based on UE measurements of serving cell signal strength, after triggering or initiating the sending of the BSR, being greater than a further signal strength threshold. In some variants, the exemplary method can also include the operations of block 1430 where after receiving the BSR (e.g., in block 1420), the network node can receive a BSR cancellation signal from the UE.

In some of these embodiments, each threshold is associated with a corresponding offset, and a BSR is received for the available data only when each of the one or more current operating conditions at the UE is less than a corresponding threshold minus a corresponding offset.

In some embodiments, the one or more thresholds that restrict sending BSRs include a first set of one or more thresholds associated with data traffic having a low priority. When the available data is associated with the low priority, a BSR is received from the UE based on the one or more current operating conditions at the UE meeting the first set of one or more thresholds. However, when the available data is associated with a higher priority, a BSR is received from the UE regardless of the one or more current operating conditions at the UE.

In other embodiments, the one or more thresholds that restrict sending BSRs include a first set of one or more thresholds associated with data traffic having a lower priority and a second set of one or more thresholds associated with data traffic having a higher priority. When the available data is associated with the lower priority, a BSR is received from the UE based on the one or more current operating conditions at the UE meeting the first set of one or more thresholds. When the available data is associated with the higher priority, a BSR is received from the UE based on the one or more current operating conditions at the UE meeting the second set of one or more thresholds. For example, the first set of one or more thresholds can be more restrictive than the second set of one or more thresholds with respect to sending BSRs.

In some embodiments, the UE is an unmanned aerial vehicle (UAV) and/or the available data includes a UAV identifier.

In some embodiments, the configuration for BSR that includes the one or more thresholds is sent via cell broadcast (e.g., in block 1410) while the UE is in a non-connected state. In such case, the BSR is received (e.g., in block 1420) after the UE enters a connected state with respect based on the one or more thresholds and on one or more current operating conditions at the UE. In some of these embodiments, the one or more current operating conditions include UE speed and UE altitude, and the UE enters the connected state when the UE speed and the UE altitude are less than corresponding thresholds.

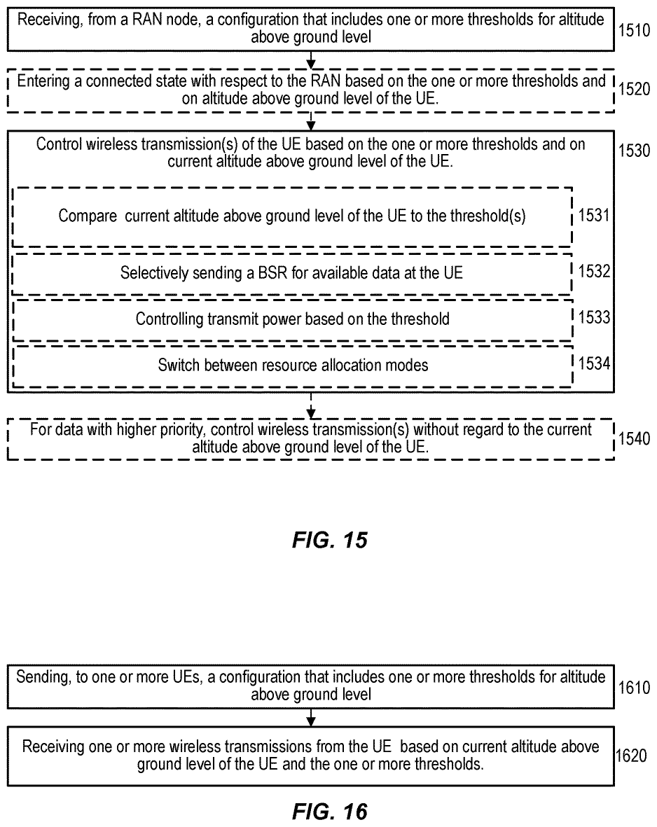

FIGS. 15-16 show further exemplary methods (e.g., procedures) for a UE and a network node, respectively. The network node may correspond to a RAN node. Although FIGS. 15-16 show specific blocks in particular orders, the operations of the exemplary methods can be performed in different orders than shown and can be combined and/or divided into blocks having different functionality than shown. Optional blocks or operations are indicated by dashed lines.

In particular, FIG. 15 shows an exemplary method (e.g., procedure) for a UE for operation in a wireless communication network. The exemplary method can be performed by a UE (e.g., wireless device) such as described elsewhere herein. In some embodiments, the UE can be a UE configured for SL communication with one or more other UEs.

The exemplary method can include the operations of block 1510, where the UE can receive, from a network node (such as a RAN node), a configuration that includes one or more thresholds for altitude above ground level. The exemplary method can also include the operations of block 1530, where the UE controls one or more wireless transmissions based on the one or more thresholds and current altitude above ground level of the UE. The one or more wireless transmissions may include one or more SL transmissions and/or one or more UL transmissions. The control of the one or more wireless transmissions may involve selectively sending a BSR for data available for transmission at the UE. The BSR can be a SL BSR or some other BSR, e.g., a UL BSR (or Uu BSR). Alternatively or in addition, the control may involve control transmit power of the UE, in particular transmit power used for the one or more wireless transmissions. Further, the control could involve switching between resource allocation modes of the UE, e.g., switching between SL resource allocation mode-1 and SL resource allocation mode-2.

In some embodiments, the control of the one or more wireless transmissions of the UE may involve one or more of:
(1531) comparing current altitude above ground level of the UE to the one or more thresholds;
(1532) sending a BSR for available data at the UE based on the one or more threshold, e.g., when the current altitude above ground level of the UE is less than the threshold; and
(1533) controlling transmit power of the UE based on the one or more thresholds; and
(1534) switching between resource allocation modes based on the one or more thresholds.

In some of these embodiments, switching between resource allocation modes in sub-block 1534 may include switching between scheduled resource allocation (e.g., based on one or more BSRs from the UE) and autonomous resource allocation to obtain SL resources for transmission of the available data (e.g., in SL resource allocation mode-1, without sending BSR).

In some embodiments, one or more thresholds include a first set of one or more thresholds associated with data traffic having a low priority. In such case, control of the one or more wireless transmissions in block 1530 may be performed based on the first set of one or more thresholds for the data having the low priority and the exemplary method also includes the operations of block 1540, where for data having a higher priority, the UE can control one or more wireless transmissions without regard to the current altitude above ground level of the UE, and in other words, without considering the one or more thresholds.

In other embodiments, the one or more thresholds include a first set of one or more thresholds associated with data traffic having a lower priority and a second set of one or more thresholds associated with data traffic having a higher priority. In such case, control of the one or more wireless transmissions (e.g., in block 1530) may be based on the first set of one or more thresholds for the data with the lower priority and based on the second set of one or more thresholds for the data with the higher priority. For example, the first set of one or more thresholds can be more restrictive than the second set of one or more thresholds.

In some embodiments, the UE is an unmanned aerial vehicle (UAV) and/or the available data includes a UAV identifier.

In some embodiments, the configuration that includes the one or more thresholds is received via cell broadcast while the UE is in a non-connected state and the exemplary method also includes the operations of block 1520, where the UE can enter a connected state based on the one or more thresholds and the current altitude above ground level of the UE. In such case, the one or more wireless transmissions may be controlled (e.g., in block 1530) after entering the connected state. In some variants, the connected state is entered when the current altitude of the UE is less than a corresponding threshold of the one or more thresholds.

In some embodiments, the one or more wireless transmissions are sent to the network node from which the configuration was received. In other embodiments, the one or more wireless transmissions are sent to a second network node (e.g., another RAN node) after a handover of the UE from the network node to the second network node.

In addition, FIG. 16 shows an exemplary method (e.g., procedure) for a network node (e.g., a RAN node) for a wireless communication netqork, according to various embodiments of the present disclosure. The exemplary method can be performed by a network node (e.g., a RAN node, such as a base station, eNB, gNB, ng-eNB, etc.) such as described elsewhere herein.

The exemplary method can include the operations of block 1610, where the network node can send, to one or more UEs, a configuration that includes one or more thresholds for altitude above ground level. In some embodiments, the UEs can be UEs configured for SL communication with one or more other UEs. The exemplary method can also include the operations of block 1620, where the network node can receive one or more wireless transmissions from the UE based on current altitude above ground level of the UE and the one or more thresholds, e.g., based on current altitude above ground level of the UE meeting (e.g., being less than or greater than, as the case may be) the one or more thresholds.

In some embodiments, the one or more thresholds include a first set of one or more thresholds associated with data traffic having a low priority. When the available data is associated with the low priority, the one or more wireless transmissions of the UE are received based on the current altitude above ground level of the UE and the first set of one or more thresholds. However, for data with a higher priority, one or more wireless transmissions of the UE may be controlled regardless of the current altitude above ground level of the UE.

In other embodiments, the one or more thresholds include a first set of one or more thresholds associated with data traffic having a lower priority and a second set of one or more thresholds associated with data traffic having a higher priority. For data having the lower priority, one or more wireless transmissions of the UE may be controlled based on the current altitude above ground level of the UE and the first set of one or more thresholds. For data having the higher priority, one or more wireless transmissions of the UE may be controlled based on the current altitude above ground level of the UE and the second set of one or more thresholds. For example, the first set of one or more thresholds can be more restrictive than the second set of one or more thresholds.

In some embodiments, the UE is an unmanned aerial vehicle (UAV) and/or the available data includes a UAV identifier.

In some embodiments, the configuration that includes the one or more thresholds is sent via cell broadcast (e.g., in block 1610) while the UE is in a non-connected state. In such case, the one or more wireless transmissions may be received (e.g., in block 1620) after the UE enters a connected state. In some of these embodiments, the UE enters the connected state when the current altitude above ground level of the UE is less than a corresponding threshold of the one or more thresholds.

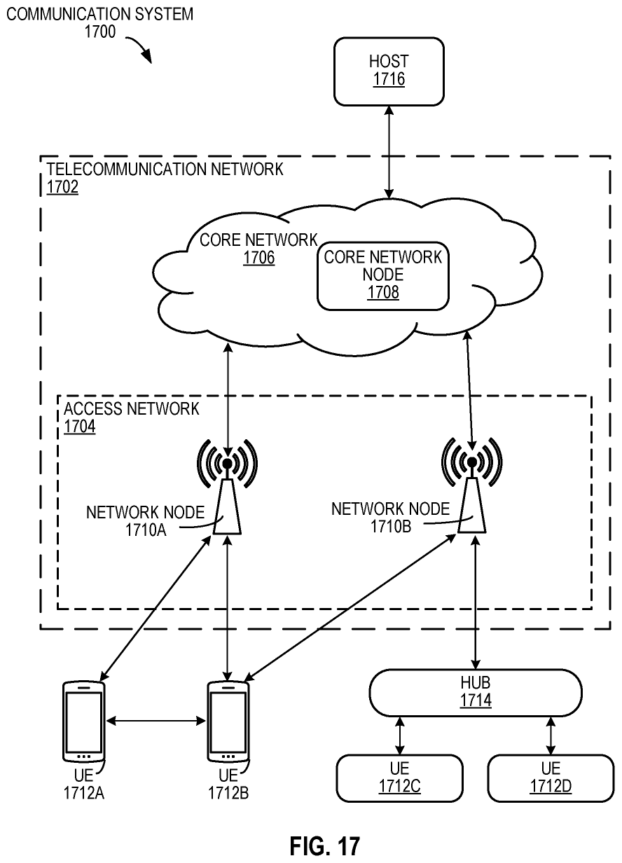

FIG. 17 shows an example of a communication system 1700 in accordance with some embodiments. In this example, communication system 1700 includes a telecommunication network 1702 that includes an access network 1704 (e.g., RAN) and a core network 1706, which includes one or more core network nodes 1708. Access network 1704 includes one or more access network nodes, such as network nodes 1710a-b (one or more of which may be generally referred to as network nodes 1710), or any other similar 3GPP access node or non-3GPP access point. Network nodes 1710 facilitate direct or indirect connection of UEs, such as by connecting UEs 1712a-d (one or more of which may be generally referred to as UEs 1712) to core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1700 may include any number of wired or wireless networks, network nodes, UEs, and/or any other components or systems that may facilitate or participate in the communication of data and/or signals whether via wired or wireless connections. Communication system 1700 may include and/or interface with any type of communication, telecommunication, data, cellular, radio network, and/or other similar type of system.

UEs 1712 may be any of a wide variety of communication devices, including wireless devices arranged, configured, and/or operable to communicate wirelessly with network nodes 1710 and other communication devices. Similarly, network nodes 1710 are arranged, capable, configured, and/or operable to communicate directly or indirectly with UEs 1712 and/or with other network nodes or equipment in telecommunication network 1702 to enable and/or provide network access, such as wireless network access, and/or to perform other functions, such as administration in telecommunication network 1702.

In the depicted example, core network 1706 connects network nodes 1710 to one or more hosts, such as host 1716. These connections may be direct or indirect via one or more intermediary networks or devices. In other examples, network nodes may be directly coupled to hosts. Core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1716 may be under the ownership or control of a service provider other than an operator or provider of access network 1704 and/or telecommunication network 1702, and may be operated by the service provider or on behalf of the service provider. Host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 1G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1702 is a cellular network that implements 3GPP standardized features. Accordingly, telecommunication network 1702 may support network slicing to provide different logical networks to different devices that are connected to telecommunication network 1702. For example, telecommunication network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1712 are configured to transmit and/or receive information without direct human interaction. For instance, a UE may be designed to transmit information to access network 1704 on a predetermined schedule, when triggered by an internal or external event, or in response to requests from access network 1704. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1714 communicates with access network 1704 to facilitate indirect communication between one or more UEs (e.g., UE 1712c and/or 1712d) and network nodes (e.g., network node 1710b). In some examples, hub 1714 may be a controller, router, content source and analytics, or any of the other communication devices described herein regarding UEs. For example, hub 1714 may be a broadband router enabling access to core network 1706 for the UEs. As another example, hub 1714 may be a controller that sends commands or instructions to one or more actuators in the UEs. Commands or instructions may be received from the UEs, network nodes 1710, or by executable code, script, process, or other instructions in hub 1714. As another example, hub 1714 may be a data collector that acts as temporary storage for UE data and, in some embodiments, may perform analysis or other processing of the data. As another example, hub 1714 may be a content source. For example, for a UE that is a VR headset, display, loudspeaker or other media delivery device, hub 1714 may retrieve VR assets, video, audio, or other media or data related to sensory information via a network node, which hub 1714 then provides to the UE either directly, after performing local processing, and/or after adding additional local content. In still another example, hub 1714 acts as a proxy server or orchestrator for the UEs, in particular in if one or more of the UEs are low energy IoT devices.

Hub 1714 may have a constant/persistent or intermittent connection to the network node 1710b. Hub 1714 may also allow for a different communication scheme and/or schedule between hub 1714 and UEs (e.g., UE 1712c and/or 1712d), and between hub 1714 and core network 1706. In other examples, hub 1714 is connected to core network 1706 and/or one or more UEs via a wired connection. Moreover, hub 1714 may be configured to connect to an M2M service provider over access network 1704 and/or to another UE over a direct connection. In some scenarios, UEs may establish a wireless connection with network nodes 1710 while still connected via hub 1714 via a wired or wireless connection. In some embodiments, hub 1714 may be a dedicated hub that is, a hub whose primary function is to route communications to/from the UEs from/to the network node 1710b. In other embodiments, hub 1714 may be a non-dedicated hub-that is, a device which is capable of operating to route communications between the UEs and network node 1710b, but which is additionally capable of operating as a communication start and/or end point for certain data channels.

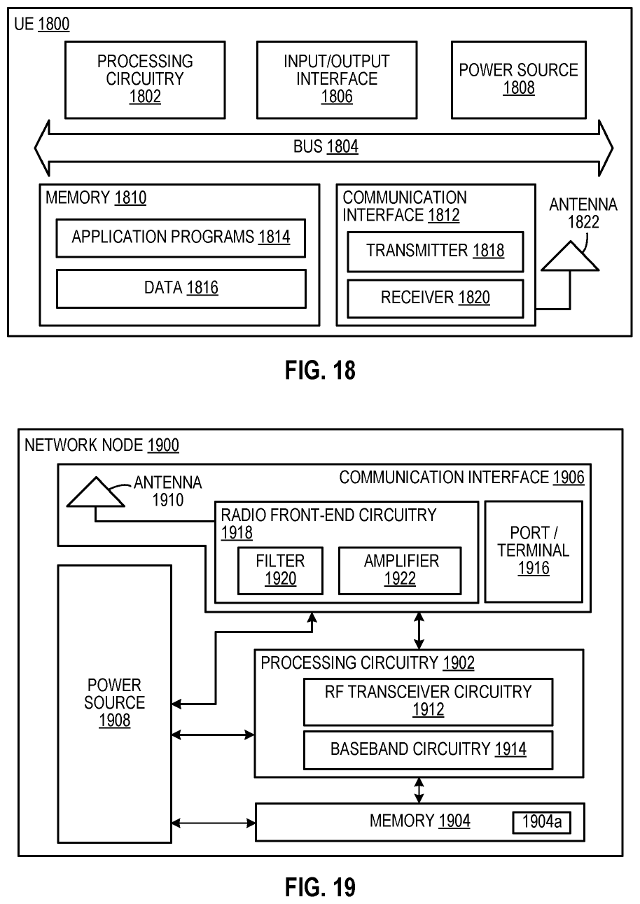

FIG. 18 shows a UE 1800 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

Processing circuitry 1802 is configured to process instructions and data and may be configured to implement any sequential state machine operative to execute instructions stored as machine-readable computer programs in memory 1810. Processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1802 may include multiple central processing units (CPUs).

In the example, input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1808 is structured as a battery or battery pack. Other types of power sources, such as an external power source (e.g., an electricity outlet), photovoltaic device, or power cell, may be used. Power source 1808 may further include power circuitry for delivering power from power source 1808 itself, and/or an external power source, to the various parts of UE 1800 via input circuitry or an interface such as an electrical power cable. Delivering power may be, for example, for charging of power source 1808. Power circuitry may perform any formatting, converting, or other modification to the power from power source 1808 to make the power suitable for the respective components of UE 1800 to which power is supplied.

Memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1810 includes one or more application programs 1814, such as an operating system, web browser application, a widget, gadget engine, or other application, and corresponding data 1816. Memory 1810 may store, for use by UE 1800, any of a variety of various operating systems or combinations of operating systems.

Memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1810 may allow UE 1800 to access instructions, application programs and the like, stored on transitory or non-transitory memory media, to off-load data, or to upload data. An article of manufacture, such as one utilizing a communication system may be tangibly embodied as or in memory 1810, which may be or comprise a device-readable storage medium.

Processing circuitry 1802 may be configured to communicate with an access network or other network using communication interface 1812. Communication interface 1812 may comprise one or more communication subsystems and may include or be communicatively coupled to an antenna 1822. Communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, transmitter 1818 and receiver 1820 may be coupled to one or more antennas (e.g., antenna 1822) and may share circuit components, software or firmware, or alternatively be implemented separately.

In the illustrated embodiment, communication functions of communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. Examples of network nodes include, but are not limited to, access points (e.g., radio access points) and base stations (e.g., Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1900 includes processing circuitry 1902, a memory 1904, a communication interface 1906, and a power source 1908. Network node 1900 may be composed of multiple physically separate components (e.g., a NodeB component and a RNC component, or a BTS component and a BSC component, etc.), which may each have their own respective components. In certain scenarios in which network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). Network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

Processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as memory 1904, to provide network node 1900 functionality.

In some embodiments, processing circuitry 1902 includes a system on a chip (SOC). In some embodiments, processing circuitry 1902 includes one or more of radio frequency (RF) transceiver circuitry 1912 and baseband processing circuitry 1914. In some embodiments, the radio frequency (RF) transceiver circuitry 1912 and baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

Memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1902. Memory 1904 may store any suitable instructions, data, or information, including a computer program, software, an application including one or more of logic, rules, code, tables, and/or other instructions (collectively denoted computer program product 1904a) capable of being executed by processing circuitry 1902 and utilized by network node 1900. Memory 1904 may be used to store any calculations made by processing circuitry 1902 and/or any data received via communication interface 1906. In some embodiments, processing circuitry 1902 and memory 1904 is integrated.

Communication interface 1906 is used in wired or wireless communication of signaling and/or data between a network node, access network, and/or UE. As illustrated, communication interface 1906 comprises port(s)/terminal(s) 1916 to send and receive data, for example to and from a network over a wired connection. Communication interface 1906 also includes radio front-end circuitry 1918 that may be coupled to, or in certain embodiments a part of, antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via antenna 1910. Similarly, when receiving data, antenna 1910 may collect radio signals which are then converted into digital data by the radio front-end circuitry 1918. The digital data may be passed to processing circuitry 1902. In other embodiments, the communication interface may comprise different components and/or different combinations of components.

In certain alternative embodiments, network node 1900 does not include separate radio front-end circuitry 1918, instead, processing circuitry 1902 includes radio front-end circuitry and is connected to antenna 1910. Similarly, in some embodiments, all or some of RF transceiver circuitry 1912 is part of communication interface 1906. In still other embodiments, communication interface 1906 includes one or more ports or terminals 1916, the radio front-end circuitry 1918, and RF transceiver circuitry 1912, as part of a radio unit (not shown), and communication interface 1906 communicates with baseband processing circuitry 1914, which is part of a digital unit (not shown).

Antenna 1910 may include one or more antennas, or antenna arrays, configured to send and/or receive wireless signals. Antenna 1910 may be coupled to the radio front-end circuitry 1918 and may be any type of antenna capable of transmitting and receiving data and/or signals wirelessly. In certain embodiments, antenna 1910 is separate from network node 1900 and connectable to network node 1900 through an interface or port.

Antenna 1910, communication interface 1906, and/or processing circuitry 1902 may be configured to perform any receiving operations and/or certain obtaining operations described herein as being performed by the network node. Any information, data and/or signals may be received from a UE, another network node and/or any other network equipment. Similarly, antenna 1910, communication interface 1906, and/or processing circuitry 1902 may be configured to perform any transmitting operations described herein as being performed by the network node. Any information, data and/or signals may be transmitted to a UE, another network node and/or any other network equipment.

Power source 1908 provides power to the various components of network node 1900 in a form suitable for the respective components (e.g., at a voltage and current level needed for each respective component). Power source 1908 may further comprise, or be coupled to, power management circuitry to supply the components of network node 1900 with power for performing the functionality described herein. For example, network node 1900 may be connectable to an external power source (e.g., the power grid, an electricity outlet) via an input circuitry or interface such as an electrical cable, whereby the external power source supplies power to power circuitry of power source 1908. As a further example, power source 1908 may comprise a source of power in the form of a battery or battery pack which is connected to, or integrated in, power circuitry. The battery may provide backup power should the external power source fail.

Embodiments of network node 1900 may include additional components beyond those shown in FIG. 19 for providing certain aspects of the network node's functionality, including any of the functionality described herein and/or any functionality necessary to support the subject matter described herein. For example, network node 1900 may include user interface equipment to allow input of information into network node 1900 and to allow output of information from network node 1900. This may allow a user to perform diagnostic, maintenance, repair, and other administrative functions for network node 1900.

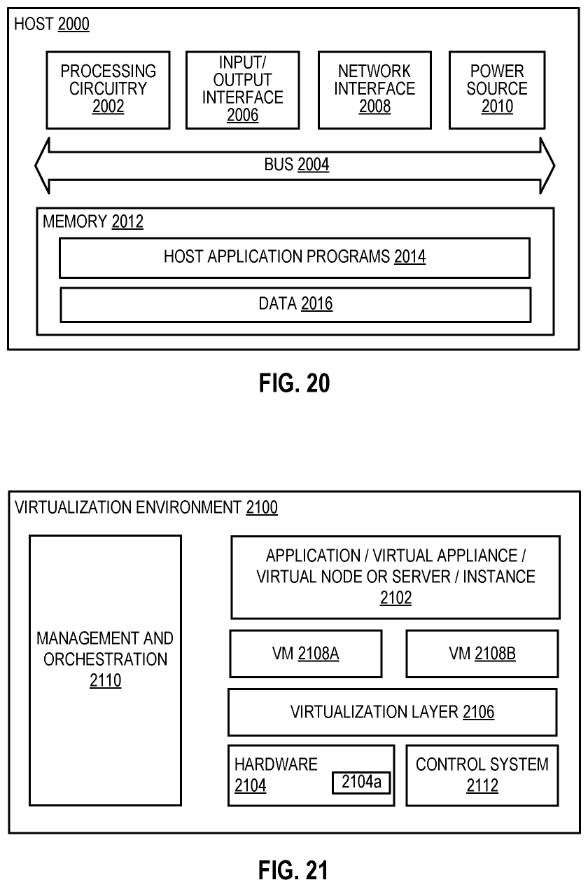

FIG. 20 is a block diagram of a host 2000, which may be an embodiment of host 1716 of FIG. 17, in accordance with various aspects described herein. As used herein, host 2000 may be or comprise various combinations hardware and/or software, including a standalone server, a blade server, a cloud-implemented server, a distributed server, a virtual machine, container, or processing resources in a server farm. Host 2000 may provide one or more services to one or more UEs.

Host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

Memory 2012 may include one or more computer programs including one or more host application programs 2014 and data 2016, which may include user data, e.g., data generated by a UE for host 2000 or data generated by host 2000 for a UE. Embodiments of host 2000 may utilize only a subset or all of the components shown. Host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 2014 may also provide for user authentication and licensing checks and may periodically report health, routes, and content availability to a central node, such as a device in or on the edge of a core network. Accordingly, host 2000 may select and/or indicate a different host for over-the-top services for a UE. Host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment 2100 to implement some of the features, functions, and/or benefits of some of the embodiments disclosed herein.

Hardware 2104 includes processing circuitry, memory that stores software and/or instructions (collectively denoted computer program product 2104a) executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a-b (one or more of which may be generally referred to as VMs 2108), and/or perform any of the functions, features and/or benefits described in relation with some embodiments described herein. Virtualization layer 2106 may present a virtual operating platform that appears like networking hardware to VMs 2108.

VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each VM 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g., such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

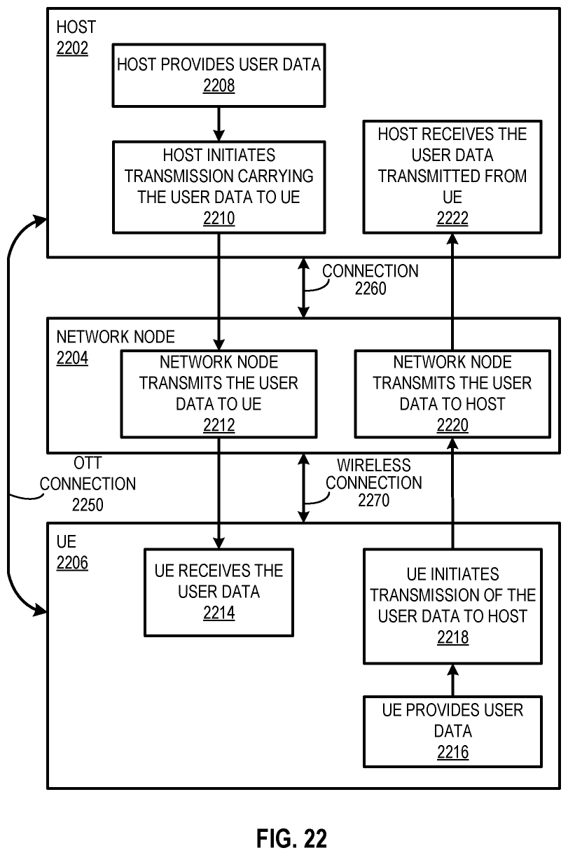

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. Host 2202 also includes software, which is stored in or accessible by host 2202 and executable by the processing circuitry. The software includes a host application that may be operable to provide a service to a remote user, such as UE 2206 connecting via an over-the-top (OTT) connection 2250 extending between UE 2206 and host 2202. In providing the service to the remote user, a host application may provide user data which is transmitted using OTT connection 2250.

Network node 2204 includes hardware enabling it to communicate with host 2202 and UE 2206. Connection 2260 may be direct or pass through a core network (like core network 1706 of FIG. 17) and/or one or more other intermediate networks, such as one or more public, private, or hosted networks. For example, an intermediate network may be a backbone network or the Internet.

UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of host 2202. In host 2202, an executing host application may communicate with the executing client application via OTT connection 2250 terminating at UE 2206 and host 2202. In providing the service to the user, the UE's client application may receive request data from the host's host application and provide user data in response to the request data. OTT connection 2250 may transfer both the request data and the user data. The UE's client application may interact with the user to generate the user data that it provides to the host application through OTT connection 2250.

OTT connection 2250 may extend via a connection 2260 between host 2202 and network node 2204 and via a wireless connection 2270 between network node 2204 and UE 2206 to provide the connection between host 2202 and UE 2206. Connection 2260 and wireless connection 2270, over which OTT connection 2250 may be provided, have been drawn abstractly to illustrate the communication between host 2202 and UE 2206 via network node 2204, without explicit reference to any intermediary devices and the precise routing of messages via these devices.

As an example of transmitting data via OTT connection 2250, in step 2208, host 2202 provides user data, which may be performed by executing a host application. In some embodiments, the user data is associated with a particular human user interacting with UE 2206. In other embodiments, the user data is associated with a UE 2206 that shares data with host 2202 without explicit human interaction. In step 2210, host 2202 initiates a transmission carrying the user data towards UE 2206. Host 2202 may initiate the transmission responsive to a request transmitted by UE 2206. The request may be caused by human interaction with UE 2206 or by operation of the client application executing on UE 2206. The transmission may pass via network node 2204, in accordance with the teachings of the embodiments described throughout this disclosure. Accordingly, in step 2212, network node 2204 transmits to UE 2206 the user data that was carried in the transmission that host 2202 initiated, in accordance with the teachings of the embodiments described throughout this disclosure. In step 2214, UE 2206 receives the user data carried in the transmission, which may be performed by a client application executed on UE 2206 associated with the host application executed by host 2202.

In some examples, UE 2206 executes a client application which provides user data to host 2202. The user data may be provided in reaction or response to the data received from host 2202. Accordingly, in step 2216, UE 2206 may provide user data, which may be performed by executing the client application. In providing the user data, the client application may further consider user input received from the user via an input/output interface of UE 2206. Regardless of the specific manner in which the user data was provided, UE 2206 initiates, in step 2218, transmission of the user data towards host 2202 via network node 2204. In step 2220, in accordance with the teachings of the embodiments described throughout this disclosure, network node 2204 receives user data from UE 2206 and initiates transmission of the received user data towards host 2202. In step 2222, host 2202 receives the user data carried in the transmission initiated by UE 2206.

One or more of the various embodiments improve the performance of OTT services provided to UE 2206 using OTT connection 2250, in which wireless connection 2270 forms the last segment. More precisely, embodiments can prevent and/or reduce unnecessary and/or excess sending of SL BSR (or preceding SR) as a UAV moves through coverage of a cell too quickly for resources to be allocated in that cell. This prevents and/or reduces unnecessary transmissions by the UAV, which reduces energy consumption and increases time of operation on a single battery charge (e.g., UAV range). Embodiments also reduce and/or eliminate unnecessary processing of SL BSRs by serving RAN nodes, which reduces energy consumption by those entities. When RAN nodes and UAVs improved in this manner are used to deliver OTT services, they increase the value of such OTT services to both end users and service providers.

In an example scenario, factory status information may be collected and analyzed by host 2202. As another example, host 2202 may process audio and video data which may have been retrieved from a UE for use in creating maps. As another example, host 2202 may collect and analyze real-time data to assist in controlling vehicle congestion (e.g., controlling traffic lights). As another example, host 2202 may store surveillance video uploaded by a UE. As another example, host 2202 may store or control access to media content such as video, audio, VR or AR which it can broadcast, multicast or unicast to UEs. As other examples, host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2250 between host 2202 and UE 2206, in response to variations in the measurement results. The measurement procedure and/or the network functionality for reconfiguring the OTT connection may be implemented in software and hardware of host 2202 and/or UE 2206. In some embodiments, sensors (not shown) may be deployed in or in association with other devices through which OTT connection 2250 passes; the sensors may participate in the measurement procedure by supplying values of the monitored quantities exemplified above, or supplying values of other physical quantities from which software may compute or estimate the monitored quantities. The reconfiguring of OTT connection 2250 may include message format, retransmission settings, preferred routing etc. ; the reconfiguring need not directly alter the operation of network node 2204. Such procedures and functionalities may be known and practiced in the art. In certain embodiments, measurements may involve proprietary UE signaling that facilitates measurements of throughput, propagation times, latency and the like, by host 2202. The measurements may be implemented in that software causes messages to be transmitted, in particular empty or ‘dummy’ messages, using OTT connection 2250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the present disclosure also include, but are not limited to, the following enumerated examples.

A1. A method for a user equipment (UE) configured for wireless sidelink (SL) communication with one or more other UEs in a radio access network (RAN), the method comprising:
receiving, from a RAN node, a configuration for SL buffer status reporting (BSR) that includes one or more thresholds that restrict sending SL BSRs to the RAN node; and
when data for SL transmission becomes available, selectively sending a SL BSR for the available data based on the one or more thresholds and on one or more current operating conditions at the UE.

A2. The method of embodiment A1, wherein the one or more thresholds include thresholds for any of the following:
speed;
altitude above ground level;
number of cells in the RAN from which signals can be simultaneously received;
geographic area in which sending SL BSR is allowed;
geographic area in which sending SL BSR is prohibited;
serving cell signal strength or quality; and
neighbor cell interference level.

A3. The method of any of embodiments A1-A2, wherein the one or more current operating conditions at the UE include any of the following:
UE speed;
UE latitude and longitude;
UE altitude above ground level;
number of cells in the RAN for which the UE measures signal strength above a minimum;
serving cell reference signal received power (RSRP) or reference signal received quality (RSRQ) measured by the UE; and
neighbor cell interference level measured by the UE.

A4. The method of any of embodiments A2-A3, wherein selectively sending a SL BSR for the available data to the RAN node based on the one or more thresholds and on one or more current operating conditions at the UE comprises:
comparing one or more of the following current operating conditions at the UE to corresponding thresholds: UE speed, UE altitude above ground level, and number of cells in the RAN for which the UE measures signal strength above a minimum;
sending a SL BSR for the available data when each of the one or more current operating conditions at the UE is less than a corresponding threshold; and
refraining from sending a SL BSR for the available data when any of the one or more current operating conditions at the UE is not less than the corresponding threshold.

A5. The method of embodiment A4, wherein sending a SL BSR for the available data when each of the one or more current operating conditions at the UE is less than a corresponding threshold comprises:
triggering or initiating the sending of the SL BSR when each of the one or more operating conditions is less than a corresponding threshold;
measuring serving cell signal strength in response to the triggering or initiating; and
completing the sending the SL BSR when the measured serving cell signal strength is greater than a further signal strength threshold.

A6. The method of embodiment A5, wherein when the measured serving cell signal strength is not greater than the further signal strength threshold, selectively sending a SL BSR for the available data to the RAN node based on the one or more thresholds and on one or more current operating conditions at the UE further comprises one of the following:
cancelling the sending of the SL BSR, when the SL BSR has not yet been sent; or
sending a SL BSR cancellation signal to the RAN node, when the SL BSR has been sent.

A7. The method of any of embodiments A4-A6, wherein refraining from sending a SL BSR for the available data when any of the one or more operating conditions is not less than the corresponding threshold comprises performing autonomous resource allocation to obtain SL resources for transmission of the available data.

A8. The method of any of embodiments A4-A7, wherein each threshold is associated with a corresponding offset, and a SL BSR is sent for the available data only when each of the one or more operating conditions is less than a corresponding threshold minus a corresponding offset.

A9. The method of any of embodiments A1-A3, wherein:
the one or more thresholds that restrict sending SL BSRs to the RAN node include a first set of thresholds associated with data traffic having a low priority;
selectively sending a SL BSR is performed based on the first set of thresholds when the available data is associated with the low priority;
the method further comprises, when the available data is associated with a higher priority, sending a SL BSR without regard to the one or more current operating conditions at the UE.

A10. The method of any of embodiments A1-A3, wherein:
the one or more thresholds that restrict sending SL BSRs to the RAN node include a first set of thresholds associated with data traffic having a lower priority and a second set of thresholds associated with data traffic having a higher priority; and
selectively sending a SL BSR is performed based on the first set of thresholds when the available data is associated with the lower priority and based on the second set of thresholds when the available data is associated with the higher priority.

A11. The method of embodiment A10, wherein the first set of thresholds are more restrictive than the second set of thresholds with respect to sending SL BSRs.

A12. The method of any of embodiments A1-A11, wherein one or more of the following applies: the UE is an unmanned aerial vehicle (UAV), and the available data includes a UAV identifier.

A13. The method of any of embodiments A1-A12, wherein:
the configuration for SL BSR that includes the one or more thresholds is received via cell broadcast while the UE is in a non-connected state with respect to the RAN;
the method further comprises entering a connected state with respect to the RAN based on the one or more thresholds and on one or more current operating conditions at the UE; and
the SL BSR is selectively sent after entering the connected state.

A14. The method of embodiment A13, wherein the one or more current operating conditions include UE speed and UE altitude, and the connected state is entered with the UE speed and the UE altitude are less than corresponding thresholds.

A15. The method of any of embodiments A1-A14, wherein one of the following applies:
the SL BSR is selectively sent to the RAN node from which the configuration was received; or
the SL BSR is selectively sent to a second RAN node after a handover of the UE from the RAN node to the second RAN node.

B1. A method for a radio access network (RAN) node configured to facilitate wireless sidelink (SL) communication between a plurality of user equipment (UEs), the method comprising:
sending, to one or more UEs, a configuration for SL buffer status reporting (BSR) that includes one or more thresholds that restrict sending SL BSRs to the RAN node; and
when data for SL transmission becomes available at one of the UEs, receiving from the UE a SL BSR for the available data based on one or more current operating conditions at the UE meeting the one or more thresholds.

B2. The method of embodiment B1, wherein the one or more thresholds include thresholds for any of the following:
speed;
altitude above ground level;
number of cells in the RAN from which signals can be simultaneously received;
geographic area in which sending SL BSR is allowed;
geographic area in which sending SL BSR is prohibited;
serving cell signal strength or quality; and
neighbor cell interference level.

B3. The method of any of embodiments B1-B2, wherein the one or more current operating conditions at the UE include any of the following:
UE speed;
UE latitude and longitude;
UE altitude above ground level;
number of cells in the RAN for which the UE measures signal strength above a minimum;
serving cell reference signal received power (RSRP) or reference signal received quality (RSRQ) measured by the UE; and
neighbor cell interference level measured by the UE.

B4. The method of any of embodiments B1-B3, wherein:
the current operating conditions at the UE include one or more of the following: UE speed, UE altitude above ground level, and number of cells in the RAN for which the UE measures signal strength above a minimum;
a SL BSR for the available data is received when each of the one or more current operating conditions at the UE is less than a corresponding threshold; and
a SL BSR for the available data is not received when any of the one or more current operating conditions at the UE is not less than the corresponding threshold.

B5. The method of embodiment B4, wherein receiving the SL BSR for the available data is further based on UE measurements of serving cell signal strength, after triggering or initiating the sending of the SL BSR, being greater than a further signal strength threshold.

B6. The method of embodiment B5, further comprising after receiving the SL BSR, receiving a SL BSR cancellation signal from the UE.

B7. The method of any of embodiments B4-B6, wherein each threshold is associated with a corresponding offset, and a SL BSR is received for the available data only when each of the one or more current operating conditions at the UE is less than a corresponding threshold minus a corresponding offset.

B8. The method of any of embodiments B1-B3, wherein:
the one or more thresholds that restrict sending SL BSRs to the RAN node include a first set of thresholds associated with data traffic having a low priority;
when the available data is associated with the low priority, a SL BSR is received from the UE based on the one or more current operating conditions at the UE meeting the first set of thresholds; and
when the available data is associated with a higher priority, a SL BSR is received from the UE regardless of the one or more current operating conditions at the UE.

B9 The method of any of embodiments B1-B3, wherein:
the one or more thresholds that restrict sending SL BSRs to the RAN node include a first set of thresholds associated with data traffic having a lower priority and a second set of thresholds associated with data traffic having a higher priority;
when the available data is associated with the lower priority, a SL BSR is received from the UE based on the one or more current operating conditions at the UE meeting the first set of thresholds; and
when the available data is associated with the higher priority, a SL BSR is received from the UE based on the one or more current operating conditions at the UE meeting the second set of thresholds.

B10. The method of embodiment B9, wherein the first set of thresholds are more restrictive than the second set of thresholds with respect to sending SL BSRs.

B11. The method of any of embodiments B1-B10, wherein one or more of the following applies: the UE is an unmanned aerial vehicle (UAV), and the available data includes a UAV identifier.

B12. The method of any of embodiments B1-B11, wherein:
the configuration for SL BSR that includes the one or more thresholds is sent via cell broadcast while the UE is in a non-connected state with respect to the RAN; and
the SL BSR is received after the UE enters a connected state with respect to the RAN based on the one or more thresholds and on one or more current operating conditions at the UE.

B13. The method of embodiment B12, wherein the one or more current operating conditions include UE speed and UE altitude, and the UE enters the connected state when the UE speed and the UE altitude are less than corresponding thresholds.

C1. A user equipment (UE) configured for wireless sidelink (SL) communication with one or more other UEs in a radio access network (RAN), the UE comprising:
communication interface circuitry configured to communicate with the one or more other UEs and with a RAN node; and
processing circuitry operatively coupled to the communication interface circuitry, whereby the processing circuitry and the communication interface circuitry are configured to perform operations corresponding to any of the methods of embodiments A1-A15.

C2. A user equipment (UE) configured for wireless sidelink (SL) communication with one or more other UEs in a radio access network (RAN), the UE being further configured to perform operations corresponding to any of the methods of embodiments A1-A15.

C3. A non-transitory, computer-readable medium storing computer-executable instructions that, when executed by processing circuitry of a user equipment (UE) configured for wireless sidelink (SL) communication with one or more other UEs in a radio access network (RAN), configure the UE to perform operations corresponding to any of the methods of embodiments A1-A15.

C4. A computer program product comprising computer-executable instructions that, when executed by processing circuitry of a user equipment (UE) configured for wireless sidelink (SL) communication with one or more other UEs in a radio access network (RAN), configure the UE to perform operations corresponding to any of the methods of embodiments A1-A15.

D1. A radio access network (RAN) node configured to facilitate wireless sidelink (SL) communication between a plurality of user equipment (UEs), the RAN node comprising:
communication interface circuitry configured to communicate with the plurality of UEs; and
processing circuitry operatively coupled to the communication interface circuitry, whereby the processing circuitry and the communication interface circuitry are configured to perform operations corresponding to any of the methods of embodiments B1-B13.

D2. A radio access network (RAN) node configured to facilitate wireless sidelink (SL) communication between a plurality of user equipment (UEs), the RAN node being further configured to perform operations corresponding to any of the methods of embodiments B1-B13. D3. A non-transitory, computer-readable medium storing computer-executable instructions that, when executed by processing circuitry of a radio access network (RAN) node configured to facilitate wireless sidelink (SL) communication between a plurality of user equipment (UEs), configure the RAN node to perform operations corresponding to any of the methods of embodiments B1-B13.

D4. A computer program product comprising computer-executable instructions that, when executed by processing circuitry of a radio access network (RAN) node configured to facilitate wireless sidelink (SL) communication between a plurality of user equipment (UEs), configure the RAN node to perform operations corresponding to any of the methods of embodiments B1-B13.

1-71. (canceled)

72. A method performed by a user equipment (UE), the method comprising:
receiving, from a node of a wireless communication network, a configuration for buffer status reporting that includes one or more thresholds that restrict sending buffer status reports (BSRs); and
when data for transmission becomes available, selectively sending a BSR for the available data based on the one or more thresholds and on one or more current operating conditions at the UE.

73. The method of claim 72, wherein:
the one or more thresholds include thresholds for any of the following: speed, altitude above ground level, number of cells from which signals can be simultaneously received, geographic area in which sending BSR is allowed, geographic area in which sending BSR is prohibited, serving cell signal strength, serving cell signal quality, and neighbor cell interference level; and
the one or more current operating conditions at the UE include any of the following: UE speed, UE latitude and longitude, UE altitude above ground level, number of cells for which the UE measures signal strength above a minimum, serving cell reference signal received power (RSRP) measured by the UE, serving cell reference signal received quality (RSRQ) measured by the UE, and neighbor cell interference level measured by the UE.

74. The method of claim 72, wherein selectively sending the BSR for the available data based on the one or more thresholds and on one or more current operating conditions at the UE comprises:
comparing one or more of the following current operating conditions at the UE to corresponding thresholds: UE speed, UE altitude above ground level, and number of cells for which the UE measures signal strength above a minimum;
sending the BSR for the available data when each of the one or more current operating conditions at the UE is less than a corresponding threshold; and
refraining from sending the BSR for the available data when any of the one or more current operating conditions at the UE is not less than the corresponding threshold.

75. The method of claim 74, wherein sending the BSR for the available data when each of the one or more current operating conditions at the UE is less than a corresponding threshold comprises:
triggering or initiating the sending of the BSR when each of the one or more operating conditions is less than a corresponding threshold;
measuring serving cell signal strength in response to the triggering or initiating; and
completing the sending of the BSR when the measured serving cell signal strength is greater than a further signal strength threshold.

76. The method of claim 75, wherein when the measured serving cell signal strength is not greater than the further signal strength threshold, selectively sending the BSR for the available data further comprises one of the following:
cancelling the sending of the BSR, when the BSR has not yet been sent; or
sending a BSR cancellation signal, when the BSR has been sent.

77. The method of claim 74, wherein:
the UE is configured for wireless sidelink (SL) communication with one or more further UEs; and
refraining from sending the BSR for the available data comprises performing autonomous resource allocation to obtain SL resources for transmission of the available data.

78. The method of claim 74, wherein each threshold is associated with a corresponding offset, and the BSR is sent for the available data only when each of the one or more operating conditions is less than the corresponding threshold minus the corresponding offset.

79. The method of claim 72, wherein:
the one or more thresholds that restrict sending BSRs include a first set of one or more thresholds associated with data traffic having a low priority;
selectively sending the BSR is performed based on the first set of one or more thresholds when the available data is associated with the low priority; and
when the available data is associated with a higher priority than the low priority, selectively sending the BSR is performed according to one of the following:
without regard to the one or more current operating conditions at the UE, such that the BSR is sent for the available data; or
based on a second set of one or more thresholds associated with data traffic having higher priority.

80. The method of claim 72, wherein one or more of the following applies: the UE is an unmanned aerial vehicle (UAV), and the available data includes a UAV identifier.

81. The method of claim 72, wherein:
the configuration for BSR that includes the one or more thresholds is received via cell broadcast while the UE is in a non-connected state with respect to the wireless communication network;
the method further comprises entering a connected state with respect to the wireless communication network when UE speed and UE altitude are less than corresponding thresholds; and
the BSR is selectively sent after entering the connected state.

82. The method of claim 72, wherein one of the following applies:
the BSR is selectively sent to a radio access network (RAN) node from which the configuration was received;
the BSR is selectively sent to a second RAN node after a handover of the UE from the RAN node to the second RAN node; or
the UE is configured for wireless sidelink (SL) communication with one or more further UEs, and the BSR is a SL BSR.

83. A method performed by a node of a wireless communication network, the method comprising:
sending, to one or more user equipment (UEs), a configuration for buffer status reporting that includes one or more thresholds that restrict sending buffer status reports (BSRs); and
when data for transmission becomes available at one of the UEs, selectively receiving from the UE a BSR for the available data based on one or more current operating conditions at the UE and the one or more thresholds.

84. The method of claim 83, wherein:
the one or more thresholds include thresholds for any of the following: speed, altitude above ground level, number of cells from which signals can be simultaneously received, geographic area in which sending BSR is allowed, geographic area in which sending BSR is prohibited, serving cell signal strength, serving cell signal quality, and neighbor cell interference level; and
the one or more current operating conditions at the UE include any of the following: UE speed, UE latitude and longitude, UE altitude above ground level, number of cells for which the UE measures signal strength above a minimum, serving cell reference signal received power (RSRP) measured by the UE, serving cell reference signal received quality (RSRQ) measured by the UE, and neighbor cell interference level measured by the UE.

85. The method of claim 83, wherein:
the current operating conditions at the UE include one or more of the following: UE speed, UE altitude above ground level, and number of cells for which the UE measures signal strength above a minimum;
a BSR for the available data is received when each of the one or more current operating conditions at the UE is less than a corresponding threshold; and
a BSR for the available data is not received when any of the one or more current operating conditions at the UE is not less than the corresponding threshold.

86. The method of claim 85, wherein selectively receiving the BSR for the available data is further based on UE measurements of serving cell signal strength, after triggering or initiating the sending of the BSR, being greater than a further signal strength threshold.

87. The method of claim 85, wherein each threshold is associated with a corresponding offset, and a BSR is received for the available data only when each of the one or more current operating conditions at the UE is less than a corresponding threshold minus a corresponding offset.

88. The method of claim 83, wherein:
the one or more thresholds that restrict sending BSRs include a first set of one or more thresholds associated with data traffic having a low priority;
when the available data is associated with the low priority, a BSR is received from the UE based on the one or more current operating conditions at the UE and the first set of one or more thresholds; and
one of the following applies when the available data is associated with a higher priority than the low priority:
the BSR for the available data is received without regard to the one or more current operating conditions at the UE; or
the BSR for the available data is selectively received based on the one or more current operating conditions at the UE and a second set of one or more thresholds associated with data traffic having higher priority.

89. The method of claim 83, wherein one or more of the following applies:
the one or more UEs are respective unmanned aerial vehicles (UAVs),
the available data at the one UE includes a UAV identifier, and
the BSR is a sidelink (SL) BSR.

90. The method of claim 83, wherein:
the configuration for BSR that includes the one or more thresholds is sent via cell broadcast while the UE is in a non-connected state with respect to the wireless communication network; and
the BSR is received after the UE enters a connected state with respect to the wireless communication network when UE speed and the UE altitude are less than corresponding thresholds.

91. User equipment (UE) comprising processing circuitry and a memory storing computer-executable instructions that, when executed by the processing circuitry, cause the UE to:
receive, from a node of a wireless communication network, a configuration for buffer status reporting that includes one or more thresholds that restrict sending buffer status reports (BSRs); and
when data for transmission becomes available, selectively send a BSR for the available data based on the one or more thresholds and on one or more current operating conditions at the UE.

92. A node configured for operation in a wireless communication network, the node comprising processing circuitry and a memory storing computer-executable instructions that, when executed by the processing circuitry, cause the node to perform the method of claim 83.
